(19) United States
(12) Patent Application Publication
(10) Pub. No.: US 2023/0342600 A1
(43) Pub. Date: Oct. 26, 2023

(54) TRAINING, ADAPTING, OPTIMIZING, AND DEPLOYMENT OF MACHINE LEARNING MODELS USING CLOUD-SUPPORTED PLATFORMS

(71) Applicant: NVIDIA Corporation, Santa Clara, CA (US)

(72) Inventors: Steve Masson, Fremont, CA (US); Farzin Aghdasi, East Palo Alto, CA (US); Parthasarathy Sriram, Los Altos Hills, CA (US); Arvind Sai Kumar, Raleigh, NC (US); Varun Praveen, Cupertino, CA (US)

(21) Appl. No.: 18/139,000

(22) Filed: Apr. 25, 2023

Related U.S. Application Data
(60) Provisional application No. 63/334,683, filed on Apr. 26, 2022.
(60) Provisional application No. 63/334,684, filed on Apr. 26, 2022.

(51) Int. Cl. G06N 3/08

(52) U.S. Cl. CPC G06N 3/08

(57) ABSTRACT

Devices, systems, and techniques for provisioning of cloud-based machine learning training, optimization, and deployment services. The techniques include providing, to a remote client device, a list of available machine learning models (MLMs), receiving from the remote client device an indication of selected MLM(s) from the provided list, identifying training settings for selected MLM(s), identifying a training data for the selected MLM(s), configuring, using the identified training settings, execution of one or more processes to train the selected MLM(s) using the identified training data, and providing to the remote client device a representation of completed training of at least one MLM.

### RELATED APPLICATIONS

This application claims the benefit of U.S. Provisional Application No. 63/334,683 “Systems and Applications for Training, Adapting, and Optimizing Machine Learning Models,” filed Apr. 26, 2022, and U.S. Provisional Application No. 63/334,684 “Systems and Applications for Early Termination of Machine Learning Model Training on Cloud-Hosted Training Platforms,” filed Apr. 26, 2022, the entire contents of which are being incorporated herein by reference.

### TECHNICAL FIELD

At least one embodiment pertains to processing resources used to perform and facilitate artificial intelligence. For example, at least one embodiment pertains to efficient training, adapting, optimizing, and deploying machine learning models.

### BACKGROUND

Machine learning is often used in office, industrial, and hospital environments, medical imaging, robotic automation, security applications, autonomous transportation, law enforcement, and many other settings. In particular, machine learning has applications in audio, image, and video processing, such as in voice, speech, and object recognition. One popular approach to machine learning involves training a computing system using training data (sounds, images, actions, facial expressions, texts, and/or other data) to identify patterns in the data that may facilitate data classification, such as the presence of a particular type of an object within a training image or a particular word within a training speech or text. Training can be supervised or unsupervised. Machine learning models can use various computational algorithms, such as decision tree algorithms (or other rule-based algorithms), artificial neural networks, and the like. After a deployment of a trained machine learning model—during inference stage—new data is input into the trained machine learning model and various target objects, sounds, sentences, actions, an/or any other target patterns can be identified using patterns and features established during training.

### BRIEF DESCRIPTION OF DRAWINGS

FIG. 1A is a block diagram of an example cloud architecture that supports efficient cloud-based training, adapting, optimizing, and deploying of machine learning models, in accordance with at least some embodiments;

FIG. 1B illustrates an example computing device capable of supporting training, adapting, optimizing, and deploying machine learning models, according to at least one embodiment;

FIG. 2 illustrates a system that supports cloud-based training, adapting, optimizing, and deploying of machine learning models, according to at least one embodiment;

FIG. 3 illustrates a processing pipeline of cloud-based training, adapting, optimizing, and deploying of machine learning models, according to at least one embodiment;

FIG. 4 illustrates a training pipeline for training machine learning models using experiment-based early stopping techniques, according to at least one embodiment;

FIG. 5 illustrates operations of the training pipeline of FIG. 4 for training machine learning models using experiment-based early stopping techniques, according to at least one embodiment;

FIG. 6 is a flow diagram of an example method of providing cloud-based services for training, adapting, optimizing, and deploying machine learning models, in accordance with at least some embodiments;

FIG. 7 is a flow diagram of an example method of training machine learning models using experiment-based early stopping techniques, in accordance with at least some embodiments;

FIG. 8A illustrates inference and/or training logic, according to at least one embodiment;

FIG. 8B illustrates inference and/or training logic, according to at least one embodiment;

FIG. 9 illustrates an example data center system, according to at least one embodiment;

FIG. 10 illustrates a computer system, according to at least one embodiment;

FIG. 11 illustrates a computer system, according to at least one embodiment;

FIG. 12 illustrates at least portions of a graphics processor, according to one or more embodiments;

FIG. 13 illustrates at least portions of a graphics processor, according to one or more embodiments;

FIG. 14 is an example data flow diagram for an advanced computing pipeline, in accordance with at least one embodiment;

FIG. 15 is a system diagram for an example system for training, adapting, instantiating and deploying machine learning models in an advanced computing pipeline, in accordance with at least one embodiment; and

FIGS. 16A and 16B illustrate a data flow diagram for a process to train a machine learning model, as well as client-server architecture to enhance annotation tools with pre-trained annotation models, in accordance with at least one embodiment.

### DETAILED DESCRIPTION

Machine learning (ML) has become a staple in a multitude of industries and fields where at least some levels of decision-making can be delegated to computer systems. Historically, development of machine learning models (MLMs) has been a province of sophisticated software developers and data scientists with expertise in efficient utilization of hardware resources available for MLM implementation. A developer had to select a type of an MLM (e.g., a neural network) and a specific architecture (e.g., a number and type of neural layers, connections, activation functions, classifiers, etc.) suitable for a specific target domain (e.g., speech, computer vision, etc.) and an application (e.g., speech recognition or synthesis). Eventually, developer packages (e.g., software development kits or SDKs) appeared that abstracted away some of the developmental tasks and enabled users with less sophisticated backgrounds to set up, train, and deploy MLMs. Such packages can effectively utilize local processing and memory resources available on a user's computer. However, not all existing platforms can be used remotely and, in particular, cannot be used to provide users with cloud-based computing resources owned and maintained by providers of large banks of processing units, e.g., including but not limited to processing units (GPUs), and memory stores.

Aspects and embodiments of the present disclosure address these and other challenges of the modern technology by providing for methods and systems that enable efficient training, adaptation, optimization, and deployment of MLM using remote-access clients to access cloud-based MLM implementation platforms. In some embodiments, a machine learning implementation application programming interface (MLI API) may be provided to a client computer, e.g., via a remote-access client (e.g., a browser-supported client). The MLI API may authenticate a remote user and provide a list of available pretrained MLMs to the remote user. The list of MLMs may be further grouped by the application domain, e.g., object recognition, action recognition, speech recognition/synthesis, conversational domain, and/or the like. Furthermore, MLI API may provide the user with a list of control commands that facilitate implementation of one or more MLM-related tasks on those cloud resources to which the user may have been granted access. For example, a TRAIN command may facilitate training of the selected MLM(s) using user-provided training and validation data, an EVALUATE command may test the trained MLM(s) using sets of data previously unseen by the MLM(s), PRUNE command may reduce complexity (e.g., the number of neural nodes) of the MLM(s), QUANTIZE command may re-format parameters of the MLM(s) from a floating-point format to a more economical integer number format, EXPORT command may deploy the trained (and optimized) MLMs on cloud-based hardware allocated to the user, and/or the like.

Execution of commands and requests received from the user via the MLI API may be orchestrated by a workflow engine (WFE). The WFE may convert control commands into low-level codes and routines that may be executed using various available ML frameworks, e.g., TensorFlow®, PyTorch®, TensorRT®, ONNX®, and the like. The WFE may schedule and supervise jobs for execution on the ML frameworks. In particular, the WFE may include a dependency checker component that determines data and resource prerequisites for execution of jobs, identifies and obtains missing dependencies, metadata, and the like. The WFE may also scan for pending and completed jobs and maintain a priority queue of pending and future jobs, including combining queues of multiple users and/or user groups.

In one example, following user authentication at a remote client device, the MLI API may provide a list of available pretrained MLMs and receive indications of user-selected MLM(s). The WFE may further receive, via the MLI API, training settings for the user-selected MLMs, such as learning rates, number of training epochs, batch size, parameters of backpropagation, and/or the like. If training settings are not provided by the user, the WFE may obtain default (e.g., cloud-stored) training settings for the selected MLMs. The WFE may also access training data (including user-provided or user-specified training data) for the selected MLM(s). The WFE may further configure, using the received training settings, execution of one or more processes to train the selected MLM using the accessed training data. In some instances, multiple candidate MLMs may be trained in parallel, e.g., using multiple sets of parallel processes. Following completion of training, a representation of the completed training may be provided to the user via the MLI API. In some embodiments, an evaluation metric may be applied to multiple trained MLM to identify one or more preferred MLMs, which are then provided (e.g., in ranked order) to the user. The user may then select, for deployment, a final MLM from the identified preferred MLMs. Various additional optimization operations may be executed for the final MLM, including, but not limited to, pruning of neurons from the final MLM, quantization of parameters of the final MLM, and the like. Following the optimization, the WFE may schedule and execute additional training of the optimized MLM. The WFE may then deploy the optimized MLM on user-accessible cloud-based hardware resources, e.g., GPUs, central processing units (CPUs), memory devices, and the like. The type and amount of such resources may depend on the user's access level, subscription plan, and the like. The WFE may determine an optimal configuration for MLM deployment, e.g., balancing MLM execution between GPUs and CPUs for minimum latency and maximum throughput. The deployed MLM may be configured to process a user input (inference) data. During the inference stage, the user may identify an input data, and the WFE may cause the MLM to be applied to the user input data to generate an output data. Throughout various stages of training, optimization, deployment, and inference, the WE may provide user with status reports and/or data logs indicating progress of the respective tasks.

The advantages of the disclosed techniques include but are not limited to flexible, efficient, and user-accessible provisioning of cloud-based training, adapting, optimizing, and deploying of machine learning models.

In some embodiments, training of an MLM may be experiment-based and may include instantiating multiple training tracks, with individual training tracks training separate candidate MLMs using different training settings and the same training data. Periodic evaluation of the training tracks and the MLMs associated with the training tracks may be performed with tracks that do not show improvement in learning of the corresponding MLMs stopped, and underperforming tracks eliminated. This enables a computing system, on one hand, to explore a significant region of training parameters space while, on the other hand, applying most of the available computational resources to training and selecting the most promising MLM candidates.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, synthetic data generation and simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially with one or more language models, systems implemented at least partially in a data center, systems for performing conversational AI operations, systems for performing light transport simulation, systems for performing collaborative content creation for 3D assets, systems implemented at least partially using cloud computing resources, systems for generating or presenting an augmented reality content, a virtual reality content, a mixed reality content, and/or other types of systems.

### System Architecture

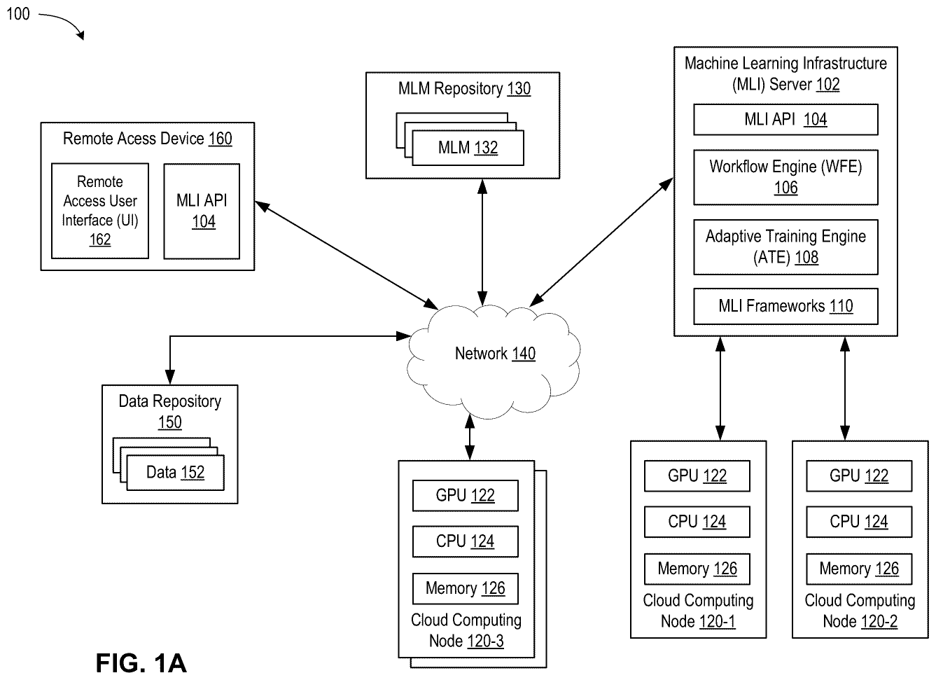

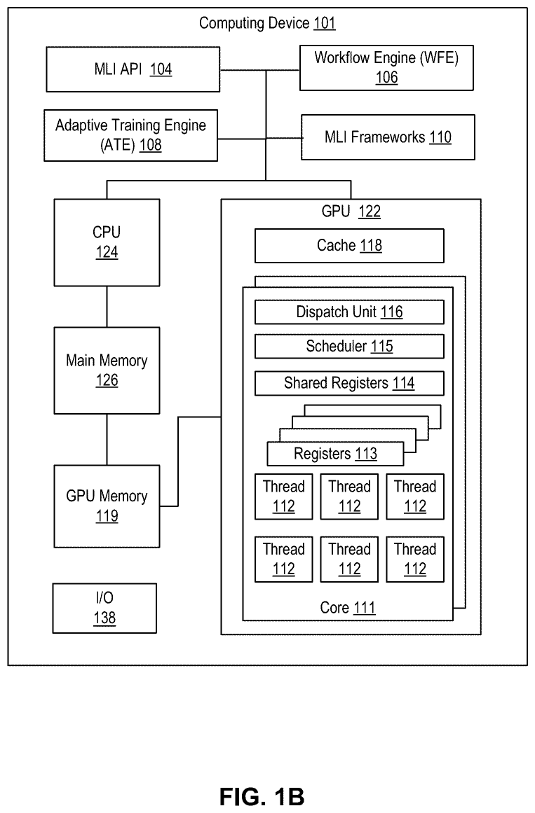

FIG. 1A is a block diagram of an example cloud architecture 100 that supports efficient cloud-based training, adapting, optimizing, and deploying of machine learning models, in accordance with at least some embodiments. As depicted in FIG. 1A, example architecture 100 may be implemented on multiple computing devices, e.g., MLI server 102, remote access device 160, cloud computing nodes 120-1, 120-2, 120-3, etc., and may use multiple storage repositories, including but not limited to a MLM repository 130 and data repository 150. In some embodiments, any of the modules and components of cloud architecture 100 may be implemented using more or fewer devices than are shown in FIG. 1A. In some embodiments, any of the modules and components of cloud architecture 100 may be implemented on a single computing device, e.g., some or all of cloud computing nodes 120-x, MLM repository 130, data repository 150, and/or other devices may be implemented on MLI server 102.

MLI server 102 may be or include a desktop computer, a laptop computer, a smartphone, a tablet computer, a server, a computing device that accesses a remote server, a computing device that utilizes a virtualized computing environment, a gaming console, a wearable computer, a smart TV, and/or any combination thereof. A user may have a local or remote (e.g., over a network) access to MLI server 102. For example, the user may access MLI server 102 via a remote access device 160, which may include any type of computing device referenced above in conjunction with MLI server 102, or any other type of computing device, or a combination of multiple computing devices. MLI server 102 may use any number of cloud computing nodes 120-1, 120-2, etc., accessed over a bus, interconnect, a local network, and so on. MLI server 102 may further use any number of cloud computing nodes 120-3 accessed over a network 140. Any, some, or all cloud computing nodes 120-x may include some or all of one or more graphics processing units (GPUs) 122, central processing units (CPUs) 124, parallel processing units (PPUs), data processing units (DPUs), or accelerators, and/or other suitable processing devices capable of performing the techniques described herein. GPU 122 and/or CPU 124 may support any number of virtual CPUs and/or virtual GPUs. Any, some, or all cloud computing nodes 120-x may include one or more memory devices, also referred to simply as memory 126 herein. MLI server 102 may also have access (e.g., over network 140) to any number of peripheral devices and/or edge devices (not shown in FIG. 1A), including but not limited to cameras (e.g., video cameras) for capturing images (or sequences of images), microphones for capturing sounds, scanners, physical or chemical sensors, or any other devices for intake of data 152. In some embodiments, data 152 may be stored in data repository 150. A user of a remote access device 160 may also have access to at least some of data 152 in data repository. In some embodiments, access to data 152 may be granted based on access levels, e.g., defined at individual user level, group level, organization level, and/or the like.

In some embodiments, MLI server 102 may include a number of engines and components that facilitate efficient cloud-based training, adapting, optimizing, and deploying of MLMs. A user (customer, end user, developer, data scientist, etc.) may interact with MLI server 102 via a remote-access user interface (UI) 162, which may include a command line, a graphics-based UI, a web-based UI (e.g., a web browser-accessible interface), a mobile application-based UI, or any combination thereof. UI 162 may display menus, tables, graphs, flowcharts, graphical and/or textual representations of software, dataflows, and workflows. UI 162 may include selectable items, which may enable the user to identify MLMs to be trained, optimized, and/or deployed, hyperparameters for MLM training, location of training and inference, and/or the like. User actions, parameters, and settings entered via remote-access UI 162 may be communicated to MLI server 102 via a portion (agent) of MLI API 104 installed on remote access device 160. In some embodiments, remote-access UI 162 and MLI API 104 may be downloaded to remote access device 160 from MLI server 102 or any other computing or memory device associated with the cloud-based MLI service. The downloaded API package may be used to install MLI API 104 and/or remote-access UI 162 to enable the user to have two-way communication with MLM server 102.

MLI API 104 may provide to the user a set of control commands that can be understood by MLI server 102 as instructions that request training, adapting, optimizing, and or deploying one or more MLMs 132, and/or instructions that request processing of inference data, which may include data 152 stored in data repository 150 and/or data generated at runtime by any sensors, such as imaging sensors, video sensors, audio sensors, physical sensors, chemical sensors, and/or any other suitable sensors, and/or combinations thereof. The control commands, made available to user via MLI API 104, may include commands that cause MLI server 104 to train one or more MLMs, augment data used in training of the MLM(s), prune (reduce complexity) of trained MLM(s), evaluate trained MLM(s), export trained MLM(s), perform inference of data using trained MLM(s), and/or the like.

MLI server 102 may deploy a number of modules and components configured to process and implement one or more control commands from a user and received via MLI API 104. Execution of commands and requests received from the user via MLI API 104 may be enabled and managed by a workflow engine (WFE) 106. WFE 106 may convert control commands received from the user into low-level codes and routines that may be executed using various available ML frameworks (backends) 110, e.g., TensorFlow®, PyTorch®, TensorRT®, ONNX®, Keras®, and/or the like. WFE 106 may schedule and supervise jobs for execution on the ML frameworks 110. WFE 106 may include a dependency checker component to determine and enforce data and resource prerequisites for execution of jobs, identify and obtains missing dependencies, metadata, and/or the like. WFE 106 may scan for pending and completed jobs and maintain a priority queue of pending and future jobs, including handling queues of multiple users and/or user groups.

ML frameworks 110 should be understood as any software resources, packages, toolkits, software development kits (SDKs) that can execute on any suitable hardware, including but not limited to one or more GPUs 122, one or more CPUs 124, and any other processing resources. Individual ML frameworks 110 may include executable codes, libraries, and configuration files. ML frameworks 110 may be used to perform training of MLMs 132, optimization of MLMs 132, evaluation (validation) of MLMs 132, inference processing using MLMs 132, and/or other suitable processing operations. In some embodiments, at least some of the functionality of MLI server 102 may be supported by (e.g., split between) multiple computing devices. For example, some of ML frameworks 110 may be located on one or more separate computing devices, e.g., one or more cloud computing nodes 120-x.

In some embodiments, MLI server 102 may include an adaptive training engine (ATE) 108 capable of efficient training of one or more MLMs 132. In particular, ATE 108 may initiate a series of experiments (tracks) to determine training hyperparameters for optimal training of MLM(s) 132, evaluate success of different experiments, and complete training of MLM(s) using a specific set of training hyperparameters, e.g., a set that maximizes MLM(s) performance, minimizes MLM(s) training time, and/or satisfies any target criteria.

MLMs 132 may be pre-trained and stored in MLM repository 130 accessible to MLI server 102 over a network 140. Network 140 may be a public network (e.g., the Internet), a private network (e.g., a local area network (LAN), or wide area network (WAN)), a wireless network, a personal area network (PAN), or a combination thereof. MLMs 132 may include regression algorithms, decision trees, support vector machines, K-means clustering models, neural networks, or any other machine learning algorithms. Neural network MLMs may include convolutional, recurrent, fully-connected, Long Short-Term Memory (LSTM) models, Hopfield, Boltzmann, or any other types of neural networks. Generating MLMs may include setting up an MLM type (e.g., a neural network), architecture, a number of layers of neurons, types of connections between the layers (e.g., fully connected, convolutional, deconvolutional, etc.), the number of nodes within each layer, types of activation functions used in various layers/nodes of the network, types of loss functions used in training of the network, and so on. Generating MLMs 132 may include setting (e.g., randomly) initial parameters (weights, biases) of various nodes of the networks. The generated MLMs 132 may be trained by using training data that may include training input(s) and corresponding target output(s). During training of MLMs 132, a training software (e.g., one of MLI frameworks 120) may identify patterns in training input(s) based on desired target output(s) and train the respective MLMs 132 to perform desired tasks. Predictive utility of the identified patterns may subsequently be verified using additional training input/target output associations before being used, during the inference stage.

FIG. 1B illustrates an example computing device 101 capable of supporting training, adapting, optimizing, and deploying machine learning models, according to at least one embodiment. In at least one embodiment, computing device 101 may support any, some or all of MLI API 104, WFE 106, ATE 108, MLI frameworks 110, and/or other programs and applications may be executed using one or more GPUs 122 (and/or other parallel processing units (PPUs) or accelerators, such as a deep learning accelerator, a data processing unit (DPU), etc.) and one or more CPUs 124. In at least one embodiment, a GPU 122 includes multiple cores 111, some or all cores being capable of executing multiple threads 112. Some or all cores may run multiple threads 112 concurrently (e.g., in parallel). In at least one embodiment, threads 112 may have access to registers 113. Registers 113 may be thread-specific registers with access to a register restricted to a respective thread. Additionally, shared registers 114 may be accessed by one or more (e.g., all) threads of the core. In at least one embodiment, some or all cores 111 may include a scheduler 115 to distribute computational tasks and processes among different threads 112 of respective core 111. A dispatch unit 116 may implement scheduled tasks on appropriate threads using correct private registers 113 and shared registers 114. Inference server 102 may include input/output component(s) 138 to facilitate exchange of information with one or more users or developers.

In at least one embodiment, GPU 122 may have a (high-speed) cache 118, access to which may be shared by multiple cores 111. Furthermore, inference server 102 may include a GPU memory 119 where GPU 122 may store intermediate and/or final results (outputs) of various computations performed by GPU 122. After completion of a particular task, GPU 122 (or CPU 124) may move the output to (main) memory 126. In at least one embodiment, CPU 124 may execute processes that involve serial computational tasks whereas GPU 122 may execute tasks (such as multiplication of inputs of a neural node by weights and adding biases) that are amenable to parallel processing. In at least one embodiment, WFE 106 may determine which processes are to be executed on GPU 122 and which processes are to be executed on CPU 124.

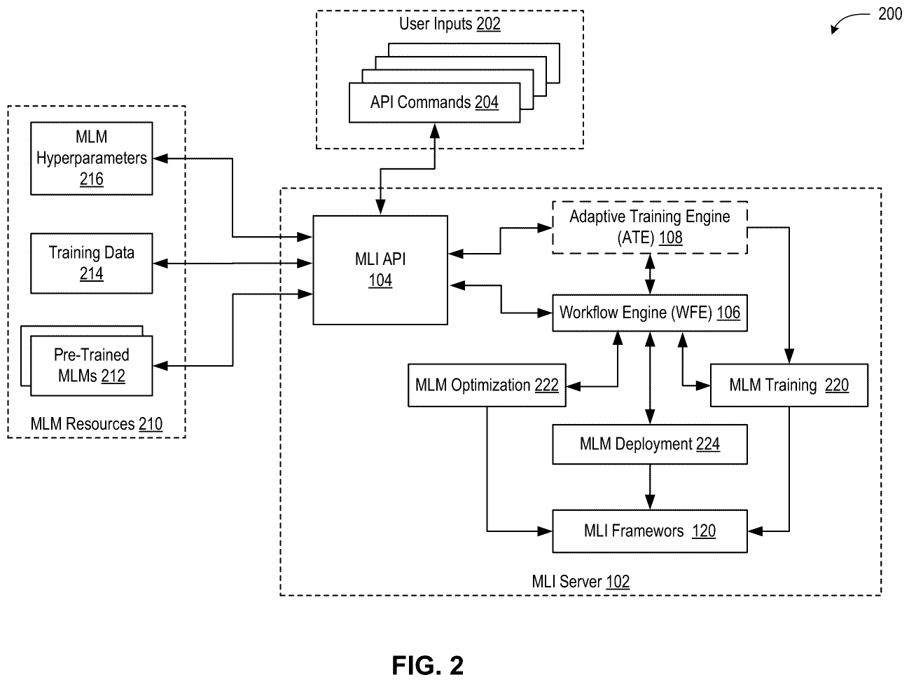

FIG. 2 illustrates a system 200 that supports cloud-based training, adapting, optimizing, and deploying of machine learning models, according to at least one embodiment. A user may receive, via MLI API 104 and a remote access UI, a list of MLMs available through the cloud-based MLI service. The available MLMs may include pre-trained MLMs 212, which may include both MLMs previously trained by the user, MLMs offered as part of the cloud-based MLI subscription, and/or other MLMs access to which may be given to the user. The user may select one or more of the available MLMs for additional training. The user may control cloud-based MLM operations via user inputs 202 that may be entered through one or more API commands 204 supported by cloud-based MLI API 104. Individual commands 204 may include one or more parameter fields to specify configurations for a respective operation to be performed by MLI server 102. For example, a TRAIN command to train a first MLM may specify one or more locations where training data that is to be used for training of the first MLM is stored. The TRAIN command may further specify MLM architecture and various training hyperparameters for the first MLM. The MLM architecture may include a number of layers, including a number of hidden layers, a number of classifiers (output layers/heads), number of neurons in various layers, types of activation functions to be used in various layers, a loss function to be used for evaluation of errors of the first MLM, and/or the like. The training hyperparameters may further include a learning rate that determines how much weights and biases of the first MLM are to change in response to errors made by the first MLM during training. The training hyperparameters may also include a size of a batch of training data and a number of training epochs (iteration of the training process).

In some embodiments, training may be performed starting from an untrained model. For example, the first MLM may initially have a random set of weights and/or biases. The training is then performed with training data 214, e.g., a user-provided or user-selected data. In some embodiments, training may be performed starting from one of pre-trained MLMs 212, which may be available as part of MLM resources 210 provided by the cloud-based MLI services. For example, a second MLM may be pre-trained using a basic set of images as a general-purpose object recognition model. Using a TRAIN command, a user may specify additional training data 214 to further train the second MLM as a domain-specific model, e.g., as a medical image object recognition model. In such instances, a user may specify (e.g., customize) some of the hyperparameters (e.g., learning rate and the number of training epochs) while other hyperparameters (e.g., related to the architecture of the model) may be fixed. In some embodiments, MLM resources 210 may include stored MLM hyperparameters 216 that may be used as default hyperparameters, if a user does not specify custom hyperparameters (or adjusts the default hyperparameters). MLM hyperparameters 216 may be specific to a particular MLM architecture and/or type, e.g., object recognition models, speech recognition models, speech synthesis models, conversational models, etc., may have different default hyperparameters.

In some embodiments, the user may request (or automate, as disclosed in more detail below) training of multiple MLMs based on a single pre-trained MLM 212 or untrained MLM. For example, the user may request that multiple MLMs be generated based on a specific pre-trained MLM 212 using different sets of training hyperparameters. In some embodiments, the user may request that multiple MLMs be generated based on different pre-trained MLMs 212 using similar (or different) sets of hyperparameters. After training is completed, ATE 108 may apply a suitable evaluation metric to compute evaluation scores and identify one or more preferred MLMs (e.g., one or more MLMs with the highest evaluation scores). In some embodiments, the evaluation metric may include accuracy of classification obtained for an evaluation set of data. The preferred MLMs may be reported to the user, via the remote access UI, together with evaluation scores. Provided with the preferred MLMs, the user may select from the one or more preferred MLMs. The selection of user-preferred MLM(s) may be communicated to MLI server 102 and MLI server 102 may deploy the user-preferred MLM(s) on cloud-based hardware resources accessible to the user. The deployed MLM(s) may then be applied to inference data specified by the user.

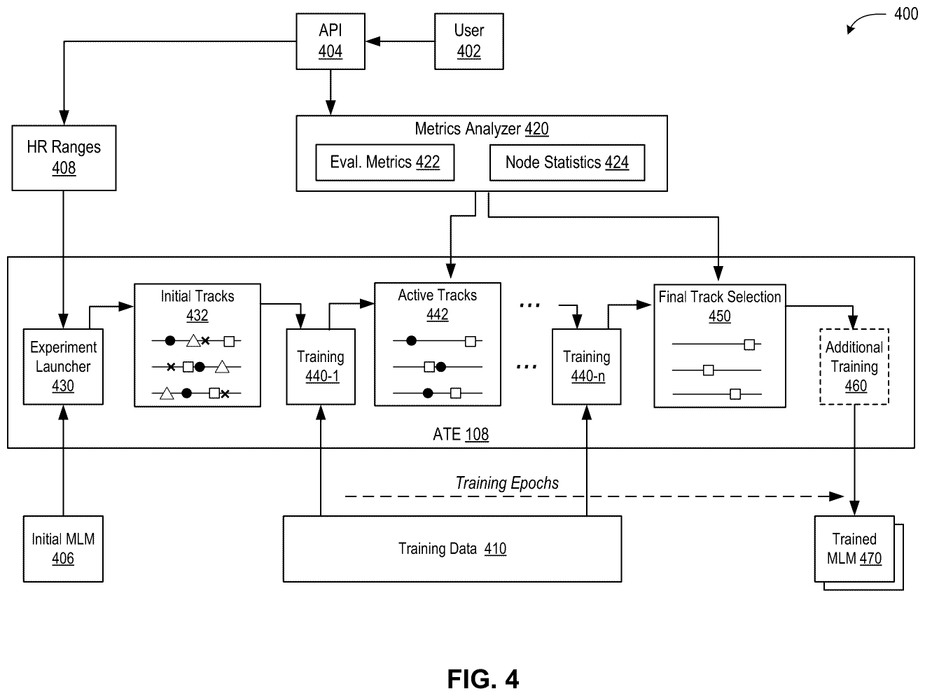

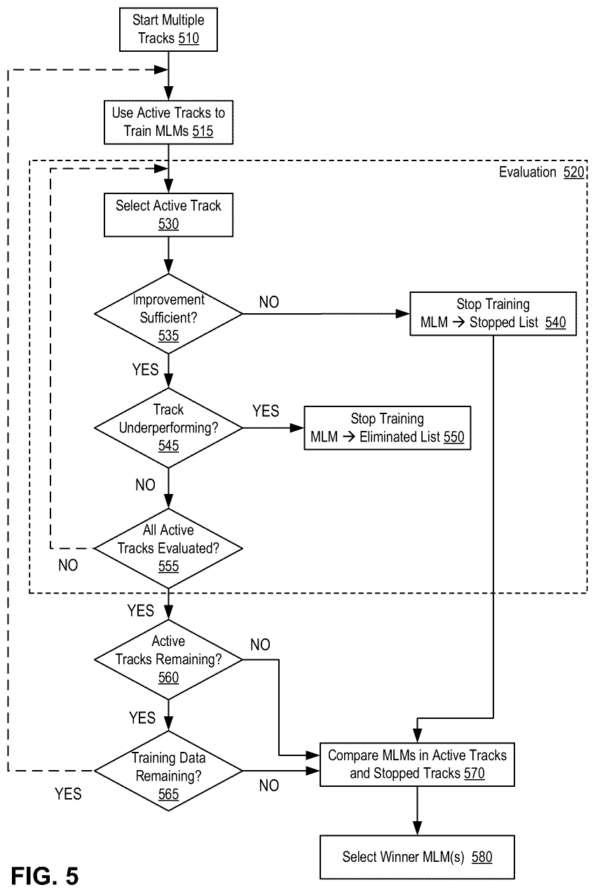

In some embodiments, hyperparameters are not fixed by default or by the user and are instead discovered by ATE 108, as disclosed in more detail below in conjunction with FIG. 4 and FIG. 5 by initiating and performing a number of experiments with different sets of hyperparameters and selecting final hyperparameters from a group of best performing sets before or after the training is completed.

API commands 204 received from a user via MLI API 104 may cause MLI server 102 to perform multiple operations. Multiple users may be requesting MLI server 102 to train, validate, optimize, deploy, use for inference of data, etc., multiple MLMs at the same time. WFE 106 may manage and coordinate (e.g., prioritize, schedule, and support) various such processes. WFE 106 may manage processes that implement MLM training 220, MLM optimization 222, MLM deployment 224, and/or other tasks. Any, some, or all of these tasks may be implemented on various available MLI frameworks 120 supported by MLI server 102.

MLM training 220 may include data augmentation that may be controlled by a user via an API command AUGMENT. Data augmentation may include introducing variations in training data 214 to improve trained model's accuracy and prevent overfitting.

MLM training 220 may further include model evaluation that may be controlled by a user via an API command EVALUATE. Model evaluation may be performed using one or more test datasets previously not seen by the model. If a model's accuracy is not sufficient, hyperparameters of the model may be modified and another iteration of the training process may be performed until acceptable accuracy of the model is achieved. Multiple iterations may eventually converge to an accurate workable model.

MLM optimization 222 may include reducing model complexity and may be controlled by a user via an API command PRUNE. Pruning algorithmically identifies and removes neurons that do not significantly contribute to the overall accuracy of a model but consume processing and memory resources. Pruning can reduce a model's complexity, memory requirements, and processing times. In some embodiments, PRUNE (and/or a separate QUANTIZE) command may provide an option to the user to quantize the model's parameters (weights and biases) from a floating-point (e.g., FP16 or FP32) format to an integer (e.g., INT8 or INT16) format, to improve performance (e.g., reduce processing time and memory footprint) without sacrificing model's accuracy.

MLM deployment 224 may include exporting a model in a format (e.g., *.etlt format) in which the model can be deployed using a target MLI framework 110 and may be controlled by a user via an API command EXPORT, which may select a specific framework, including but not limited to TensorFlow® frameworks, PyTorch® frameworks, TensorRT® frameworks, ONNX® frameworks, Keras® frameworks, and/or the like. In those instances where the user does not specify an inference framework for a particular model, MLM deployment 224 may deploy that particular model using a default MLI framework 110. In some embodiments, the default MLI framework may be the same for all models. In some embodiments, the default MLI framework may be dependent on a type of the model, e.g., different default MLI frameworks may be set for medical imaging models, speech recognition models, text recognition models, physical/chemical sensor models, and so on. In some embodiments, default MLI frameworks may be set by an administrator of MLI server 102. In some embodiments, default MLI frameworks may be set (or modified) by a user.

MLM deployment 224 may further include using a trained, optimized, and deployed model for inference on new user-specified data and may be controlled via an API command INFER, which may identify the inference data (e.g., by a source of a stream or a storage location) and select one or more deployed MLMs for processing of the inference data. In some embodiment, API command INFER may specify a processing (hardware) platform on which a particular model is to be executed, e.g., one or more CPUs, one or more GPUs (e.g., using CUDA® toolkit), and/or a combination of CPU and GPU. In some embodiments, parameters of INFER command may indicate a portion (e.g., subnetwork) of a model to be executed on CPU and a portion of the model to be executed on GPU. API command INFER may also specify execution modes for inference processing of various models, such as single-GPU processing, parallel processing on multiple GPUs, and so on.

The above examples of API-supported commands are intended to be illustrative and not exhaustive, as various other commands may be defined by a developer of MLI API 104.

MLM(s) trained using cloud-based system 200 may be stored in a private storage space accessible to the user (and, possibly, to user's team and/or organization, depending on established access policies), but not accessible to unauthorized users.

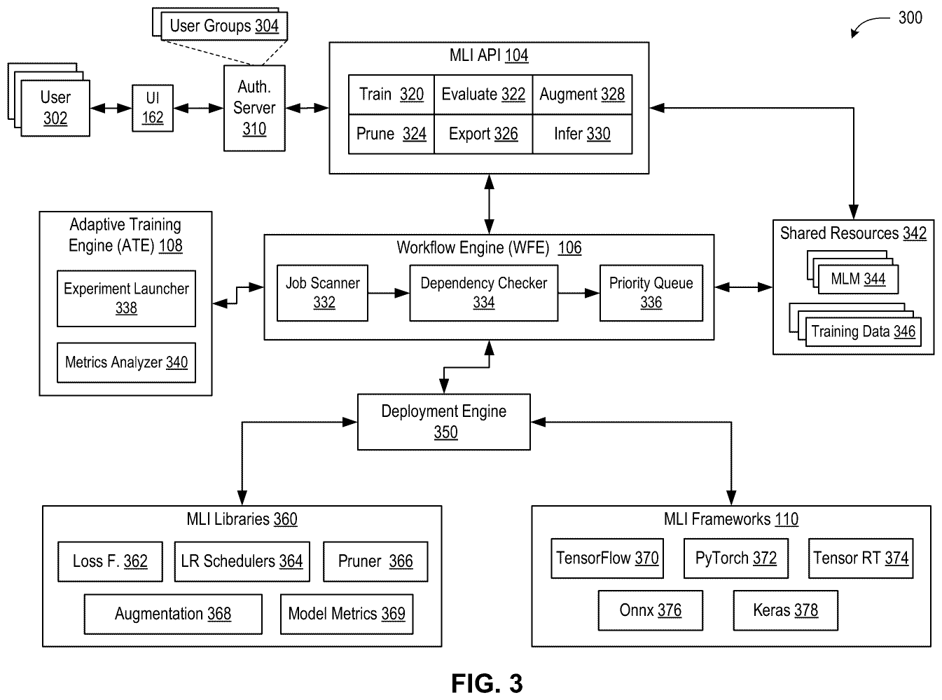

FIG. 3 illustrates a processing pipeline 300 of cloud-based training, adapting, optimizing, and deploying of machine learning models, according to at least one embodiment. Processing pipeline 300 may receive one or more user inputs from a user 302 via MLI API 104, e.g., via remote access UI 162, which may include a command line interface, a browser-based interface, a proprietary graphics interface, and/or any combination thereof. Access of user 302 to MLI API 104 may be controlled by authentication server 310. Authentication server 310 may enforce various access categories and/or user groups 304, e.g., at organizational level, group level, user level, and/or the like. For example, an administrator of the MLI cloud-based services may identify access rights for a specific organization (company, government office, etc.), which may include an amount of processing and memory resources allocated for use by the organization, such as a number of GPUs/CPUs, virtual GPUs/CPUs, units of memory, network bandwidth, and/or the like. Individual organizations may further establish group (team) rights and individual group rights for various members of the organizations. For example, a specific user may be granted up to one GPU during peak hours and up to two GPUs during off-peak hours. Authentication server 310 may enforce access rights of various users, teams, organizations, and the like, using passwords, cryptographic encryption, digital authentication, and/or other suitable techniques of data protection. For example, while pre-trained models may be accessible to multiple users/groups of users, models that are trained on user's data may protected by authentication server 310 from unauthorized access by outside users/groups. Similarly protected may be various user's data, including training data, training hyperparameters, training/optimizing/deployment logs, data generated by deployed models, and/or any other pertinent data.

Inputs from user 302 may be delivered to MLI API 104 via a number of API commands (e.g., as described in conjunction with FIG. 2 including but not limited to TRAIN command 320, EVALUATE command 322, PRUNE/QUANTIZE command 324, EXPORT command 326, AUGMENT command 328, INFER command 330, and/or other suitable commands as may be defined by MLI API 104 and supported by WFE 106. Inputs from user 302 may identify user-specific training data (not explicitly shown in FIG. 3) and various shared resources 342, e.g., MLMs 344 (which may include pre-trained models) and training data 346.

WFE 106 may receive remote device-generated commands via MLI API 104 and implement functionality requested by user 302 as a series of one or more jobs. A [symbol] ob should be understood as any unit of computing work that WFE 106 identifies and schedules for execution of any suitable processing device (e.g., GPU(s), CPU(s), etc.), or any combination of processing devices. A job may be executed by processing devices subject to instructions of any suitable software program, including one or more MLI frameworks 110. For example, a received API command TRAIN to train a specific model may be converted by WFE 106 into a set of jobs, such as retrieve training data, convert training data into a format native to a target MLI framework 110, access a pre-trained model, generate a list of training specifications (including but not limited to model hyperparameters), provide the pre-trained model to the target MLI framework 110, and/or any other suitable jobs.

WFE 106 manages various jobs pertaining to operations related to task requested by various users 302 of the cloud-based MLI service, such as training of models, optimization of models, deployment of models. Different jobs may have different compute/memory requirements and may be scheduled for execution on different cloud computing nodes 120-x (with reference to FIG. 1A). Some jobs may be executed on multiple GPUs and/or CPUs. Some jobs may be executed provided that some prerequisites (job dependencies) are met, such as availability of certain datasets (e.g., training datasets), pre-trained models, and/or the like. WFE 106 may track dependencies of individual jobs and determine when various jobs have all prerequisites completed prior to scheduling jobs for execution.

In some embodiments, WFE 106 may include a job scanner 332, a dependency checker 334, and a priority queue 336. Priority queue 336 may list various jobs related to tasks requested to be performed by various users. Individual entries associated with specific jobs in priority queue 336 may have various dependencies listed as part of the description of the corresponding jobs. Jobs in priority queue 336 may be ranked by WFE 106 according to multiple priority metrics. For example, jobs may be ranked by a priority assigned to user 302, with some users (e.g., users assigned to safety-sensitive or security-sensitive teams) receiving higher priority. Jobs may be ranked by an additional priority specifically assigned by user 302. Jobs may be additionally ranked by a job type. For example, jobs associated with a particular task may have a higher priority (given other priorities being the same) than a different task, e.g., jobs related to training of models may have a higher priority than jobs related to pruning or deploying of models, or vice versa.

Job scanner 332 may scan priority queue 336, e.g., at regular intervals or in a loop fashion (restarting the scan from the beginning upon reaching the end of the queue), and apply dependency checker 334 to identify jobs whose dependencies have been satisfied. Jobs with completed dependencies may be moved to the top of priority queue 336 into the Ready list for immediate execution. When multiple jobs have all dependencies met, the execution order may be determined by the relative priorities of the jobs placed on the Ready list. For example, job dependencies may include availability of hardware (processing and memory) resources (e.g., one or more cloud computing nodes 120-x) so that hardware resources may become available for multiple jobs at the same time causing WFE 106 to select the highest priority job(s) for immediate execution. As additional jobs are added to the Ready list of priority queue 336, job scanner 332 may rearrange the Ready, e.g., moving later-added jobs with higher priorities ahead of earlier-added jobs with lower priorities.

In some embodiments, priority queue 336 may be provided to user 302 as part of a jobs report, including the Ready list and the list of jobs previously executed and/or currently being executed, via remote access UI 162. In one non-limiting example, WFE 106 may maintain priority queue 336 in a JOBS.yam1 file or a similar file. In some embodiments, user 302 may receive a part of priority queue 336 related to the tasks of user 302 (or tasks of the user's team, organization, etc., depending on the user's access rights) whereas other parts of priority queue 336 may be removed or redacted. Informed by priority queue 336, user 302 may change priority of jobs, e.g., assigning higher priority to some tasks and lower priority to other tasks. User 302 may also change hardware requested for execution of some tasks. For example, user 302 may have previously requested four GPUs for training of a particular model, but has observed that such a number of GPUs is unlikely to be available given the current utilization of various cloud computing nodes. Correspondingly, user 302 may modify the request to two GPUs. In some embodiments, user 302 may receive the jobs report in the form of a graph whose nodes indicate jobs to be executed and edges indicate job dependencies. The graph may be a directional acyclic graph (DAC) with edges incoming into a given node indicating which prior jobs have to be completed for the job associated with the node to be scheduled.

MLI API 104 may enable user 302 to send requests to WFE 106 to handle various jobs. More specifically, MLI API 104 may support various dataset requests, e.g., requests to list, create, update, delete, execute, and retrieve status of jobs, as well as upload and download data:
dataset
   ├list
   ├status
   ├create
   ├update
   ├delete
   ├upload
   ├job:
      ├list
      ├create
      ├status
      ├delete

Similarly, MLI API 104 may support various model requests:
model
   ├list
   ├status
   ├create
   ├update
   ├delete
   ├download
   ├job:
      ├list
      ├create
      ├status
      ├pause
      ├resume
      ├delete

Jobs that are moved from the Ready list of priority queue 336 to execution may be passed to deployment engine 350 that formats the jobs for execution using one or more MLI frameworks 110, e.g., TensorFlow® 370, PyTorch® 372, TensorRT® 374, ONNX® 376, Keras® 378, and the like. Execution of jobs may be facilitated by one or more MLI libraries 360. MLI libraries 360 may include various loss functions 362 that are used to evaluate errors in training, learning rate schedulers 364 to adjusts the learning rate between training epochs (iterations), pruners 366 to eliminate inefficient neurons. MLI libraries 360 may further include one or more data augmentation libraries 368 to generate variations in the training data, model metrics 369 that may be used to evaluate trained models, and/or other libraries.

In some embodiments, logs and various other metadata generated during execution of various jobs may be converted (e.g., from a proprietary format of the cloud-based MLI service) into a user-readable format, e.g., *.yaml format and delivered to user 302 via remote access UI 162. In some embodiments, collection, conversion, and provisioning of the logs/metadata may be performed in real time, as the jobs are being executed.

In some embodiments, processing pipeline 300 may further include ATE 108 for running multiple training experiments in parallel. ATE 108 may include an experiment launcher 338 to run multiple tracks for individual models being trained. Individual tracks may have unique set of hyperparameters and may achieve different progress in training efficiency (e.g., speed) and accuracy. A metrics analyzer 340 may evaluate various tracks, remove underperforming (e.g., experiments that learn slowly, fail to converge, or even degrade over time), and eventually select one or several top performing experiments, e.g., as disclosed in more detail below in conjunction with FIGS. 4-5.

FIG. 4 illustrates a training pipeline 400 for training machine learning models using experiment-based early stopping techniques, according to at least one embodiment. In some embodiments, training pipeline 400 may be implemented as part of MLI services provided by cloud-based architecture 100 of FIG. 1A. In some embodiments, training pipeline 400 may be implemented on a local computer. Training pipeline 400 may be supported by adaptive training engine (ATE) 108. A user 402 may communicate with ATE 108 via API 404, which may be an MLI API 104 of cloud-based architecture 100 or a local device API. User 402 may identify an initial MLM 406 for experiment-based training and may further identify training data 410. Initial MLM 406 may be a domain-specific MLM (e.g., an object recognition model, a speech generation model, a gaze detection model, and/or any other model) that has been pretrained using suitable domain-specific data. In some instances, initial MLM 406 may be a model that has not been previously trained, e.g., a model with a starter set of weights and biases, e.g., a set of random weights and biases.

ATE 108 may be capable of launching multiple experiments or training tracks, also referred to for brevity as “tracks” herein. Different tracks may be launched using different sets of hyperparameters (HRs). Hyperparameters may include a learning rate, a regularization constant, parameters of gradient descent, a number of training epochs, a number of branches in a decision tree, a number of clusters in a clustering algorithm, and/or the like. In some embodiments, user 402 may specify target hyperparameter ranges 408, e.g., including minimum and maximum learning rates, [LRₘᵢₙ, LRₘₐₓ], and/or minima and maxima of other hyperparameters. In some embodiments, user 402 may specify evaluation metrics 422 to be used by a metrics analyzer 420 to assess viability and progress of various tracks, as described in more detail below.

Experiment launcher 430 may start multiple tracks, individual tracks training separated instances of an MLM starting from initial MLM 406 and using training data 410. Different tracks may be associated with different sets of training settings, e.g., sets of hyperparameters. For example, experiment launcher 430 may select M training hyperparameters as variables for the tracks (which may further include any number of hyperparameters that are uniform across different tracks). Experiment launcher 430 may then select n₁ different values of hyperparameter HR₁, n₂ different values of hyperparameter HR₂, etc., and n₁ different values of hyperparameter HRₘ, for n₁×n₂× . . . ×nₘ different combinations to be used by the same number of tracks. In some embodiments, some of the combinations may be dropped, so that the total number of tracks may be lower than n₁×n₂× . . . ×nₘ. Hyperparameters HRⱼ may be selected using various possible selection routines. In one example, nⱼ hyperparameters may be selected equidistantly within respective intervals [HRⱼ₋ₘᵢₙ, HRⱼ₋ₘₐₓ]. In another example, nⱼ hyperparameters may be selected randomly within respective intervals [HRⱼ₋ₘᵢₙ, HRⱼ₋ₘₐₓ], e.g., according to any suitable distribution, which may include a Gaussian distribution, or some other distribution. In yet another example, the distribution may be (or associated with) a historical distribution related to a number of times that various hyperparameter values have been used in winning tracks for previously trained models or a subset of previously trained models, e.g., models of a similar type (e.g., text recognition models may have a different historical distribution of successful hyperparameters than safety hazard detection models) or architecture (e.g., convolutional neural networks may have a different historical distribution of successful hyperparameters than Boltzmann state machines).

In some embodiments, API 404 may cause the sets of hyperparameters selected for various tracks to be displayed on a UI (e.g., remote access UI 162 in FIG. 1A or a local machine UI) to user 402. User 402 may review the displayed hyperparameters and change some of the hyperparameters prior to ATE 108 starting the tracks. User 402 may also delete some of the tracks and/or create additional tracks for ATE 108 to initiate and execute. In some embodiments, user 402 may be able to modify hyperparameters of the tracks while the training is ongoing. ATE 108 may maintain logs (including real-time logs) associated with the training and store and/or make these logs available to user 402 during and/or after the training. The logs may include (for some or all tracks) hyperparameters of various tracks, identification of the portions of training data 410 used during various stages (epochs) of training, evaluation metrics and/or statistical distributions collected during various evaluation stages of training, and/or the like.

As illustrated in FIG. 4, initial tracks 432 started by experiment launcher 430 may undergo a first stage of training 440-1. Four different initial tracks 432 are indicated symbolically in FIG. 4, each track having different values of three hyperparameters, e.g., a first track having three values of hyperparameters indicated with circles placed along the three hyperparameter axes, a second track indicated similarly with squares, a third track indicated with crosses, and a fourth track indicated with triangles. After a certain portion of training data 410 has been used in training, metrics analyzer 420 may evaluate the initial tracks and determine if any of the tracks are to be eliminated or stopped. A track is referred to as “eliminated” if performance of the corresponding partially trained MLM associated with the track has been determined (e.g., by metrics analyzer 420) to be inferior to performance of at least one other track. The partially-trained MLM of the eliminated track is discarded and not used in a selection of a winner track. A track is referred to as “stopped” if it has been determined (e.g., by metrics analyzer 420) that additional training of the MLM associated with the corresponding track is not justified in view of the processing cost that such training would entail, such that further improvement to the corresponding MLM is predicted to be small. A stopped track may nonetheless have a viable MLM that may eventually (when all tracks have either been eliminated, stopped, or completed) be considered as a candidate to a winning track, e.g., by comparing the performance of the MLM associated with the stopped track to MLMs associated with completed tracks and/or MLMs associated with other stopped tracks.

To evaluate a track, metrics analyzer 420 may perform a variety of evaluation operations. In one illustrative example, metric analyzer 420 may access a loss function and compute a loss (the quantified difference between an output of the MLM associated with the track and a desired—ground truth—output of the MLM) for a certain number of training inputs. Metric analyzer may assess the dynamics of the loss L(j) as a function of an index j enumerating units of input data, which may be units for which separate classification outputs are determined, e.g., separate images, speech segments, array of sensor readings, and/or the like. Metrics analyzer 420 may assess an evaluation window that includes, e.g., the last N losses L(1) . . . L(N) and compute a global improvement I=L(1)−L(N) for the entire evaluation window. In some embodiments, to reduce influence that possible random spikes or drops in the boundary values L(1) and L(N) may have, the global improvement may be computed as an average of improvements achieved over multiple sliding windows within the evaluation window. For example, if the size of the sliding window is selected to be n, then N−n+1 improvements may be defined, e.g., as

I₁=L(1)−L(n),

I₁=L(2)−L(n+1),

I_{N-n+1}=L(N−n+1)−L(N),

and the global improvement may be defined as the average,

$$I = \frac{1}{N - n + 1} {\sum }_{i = 1}^{N - n + 1} {I}_{i} ,$$

The computed improvement (e.g., global improvement I) may serve as a proxy for a projected improvement that is likely to occur if the training of the track is continued. The improvement may be compared to a cost of processing C associated with additional N units of training data 410 (or a specific number of training epochs consisting of a certain number of units of training data). Cost of processing C may be any suitable metric, which may be defined by user 402 via API 404 or a metric defined by metrics analyzer 420. In one implementation, cost of processing C may be determined, e.g., up to a weight factor W (defined by user 402 and/or metrics analyzer 420), by a number P of processing operations (e.g., flops) associated with training of additional N (or some other number) of units of training data 410: C=P×W. In some embodiments, weight factor W may be dynamic, e.g., dependent on the current utilization of the system that performs the training. For example, during peak hours of cloud services weight factor W may be increased while during off-peak hours weight factor W may be decreased. If metrics analyzer determines that improvement is less than the cost, I<C, the corresponding track may be stopped and further training of the MLM associated with the track will not be performed. If I>C (or I≥C), the track may be maintained as active, and training of the MLM associated with this track may be continued.

The decision to stop a track may also be informed by changes to the MLM parameters that occur, e.g., the changes that have occurred over the last N units of training data. More specifically, a node statistics module 424 of metric analyzer 420 may analyze a distribution D(w) of nodal weights w of the corresponding MLM (and, similarly, a distribution of biases), and determine whether the distribution has changed over the last N (or any other number) units of training data. In some embodiments, the change may be quantified using the mean square difference, e.g.,

$$Δ = {\sum }_{w} {( {D}_{1} ( w ) - {D}_{L} ( w ) )}^{2}$$

of the distributions at the beginning and at the end of the evaluation window. As described above, the change Δ may also be computed as an average over multiple sliding windows inside the evaluation window. The change Δ may be used together (e.g., as the weighed sum) with improvement I, instead of improvement I, or in some combination with improvement I. In one example embodiment, comparison of improvement I to cost C may be used as a first stage evaluation. If I>C, the change Δ may be used during a second stage evaluation. If it is determined that change Δ is less than a certain (e.g., empirically set) threshold Δ<Δ_{T}, meaning that no significant further learning is happening, the track may be stopped.

As disclosed above, a track may be stopped based on the lack of further improvement regardless of how well or poorly the associated MLM is performing. In particular, a track may be stopped as a result of advantageously chosen hyperparameters of the track and the associated model achieving quick success with a modest amount of training.

In addition to stopped tracks, some tracks may be eliminated because the associated MLMs may be underperforming relative to MLMs of other tracks. For example, a relative performance of track j and track k may be computed, e.g., as a difference of losses over the last N units of training data for the two tracks,

$${P}_{j k} = \frac{1}{N} {\sum }_{i = 1}^{N} ( {L}_{j} ( i ) - {L}_{k} ( i ) ) .$$

Relative performance matrix Pⱼₖ is an anti-symmetric matrix with up to M(M−1)/2 different elements, where M is the number of active tracks. Metric analyzer 420 may compute relative performance matrix Pⱼₖ and eliminate those tracks k that have Pⱼₖ>P_{T} for at least some other tracks j, where P_{T} may be an empirically set threshold, e.g., a set percentage of the average loss across the active tracks,

$${P}_{T} = \frac{1}{N M} {\sum }_{i = 1}^{N} {\sum }_{j = 1}^{M} {L}_{j} ( i ) ,$$

or some other metric. In some embodiments, a track may be eliminated if at least two, three, etc., tracks j have performance above that of track k, namely, if Pⱼₖ>P_{T} for more than one track j.

Tracks that are not stopped or eliminated are referred to as active tracks 442. For example, two active tracks 442 are shown to remain after training 440-1. Additional evaluation of tracks may subsequently be performed, e.g., the first track (circles) and the second track (squares). Evaluation of tracks may be performed multiple times, e.g., after the next portion of training data 410 has been used. Each subsequent evaluation may be performed as disclosed above with metrics analyzer 420 placing more tracks into stopped and/or eliminated category. After all tracks have been stopped and/or eliminated or after all training data 410 has been used, ATE 108 may perform a final track selection 450. In some embodiments, a single trained MLM 470 is selected, e.g., the MLM with the best performance, such as fewest number of mistaken classifications over a test dataset. In some embodiments, multiple trained MLMs 470 may be selected, e.g., several MLMs with the top performances over the test dataset. In some embodiments, trained MLM(s) 470 may undergo additional training 460 using more training data. For example, training data 410 may be used to reduce the number of models from a large number of initial MLMs/tracks to one or several, which then undergo further training using additional data.

API 404 may provide (via a UI, e.g., remote access UI 162 in FIG. 1A or a local machine UI) to user 402 real-time training metrics collected and/or generated by metrics analyzer 420. In particular, API 404 may cause displaying various sets of hyperparameters for different tracks, evaluation metrics for different tracks, indications of which tracks are active, stopped, and/or eliminated. Using API 404, user 402 may stop or eliminate any specific tracks or, conversely, restart stopped tracks and/or revive eliminated tracks. In some embodiments, training of any active tracks may be performed in parallel, e.g., using multiple processing units (GPUs, CPUs, etc.) or multiple virtual processing units (vGPUs, vCPUs, etc.). In some embodiments, e.g., when processing resources are limited, at least some of the tracks may be processed in series. For example, a first portion of training data 410 may be used to train a first MLM associated with the first track. Subsequently, the same first portion of training data 410 may then be used to train a second MLM associated with the second track, and so on. Evaluation of tracks may then be performed as disclosed above (e.g., once multiple MLMs have been trained with the first portion of training data 410), and some of the tracks may be stopped and/or eliminated, as disclosed above. A second portion of training data 410 may then be used to evaluate the remaining active tracks, and so on. In some embodiments, a combined serial/parallel processing may be used with one batch (fraction) of active tracks trained in parallel and other batches trained after the first batch has been trained.

FIG. 5 illustrates operations of the training pipeline of FIG. 4 for training machine learning models using experiment-based early stopping techniques, according to at least one embodiment. At block 510, a training engine (e.g., ATE 108) may start multiple tracks with different sets of training hyperparameters. Initially, all starting tracks may be active tracks. At block 515, the training engine may use active tracks to train MLMs associated with the respective tracks. After some common portion of training data has been used for training of the active tracks, an evaluation 520 may be performed. Evaluation 520 may include selecting, at block 530, one of the active tracks and determining, at decision-making block 535, if improvement is sufficient (e.g., if improvement metric is exceeding a cost metric, I≥C). If improvement is not sufficient (e.g., if I<C), the track may be placed, at block 540, on the list of stopped tracks. If improvement is sufficiently large, evaluation 520 may include determining, at block 545, is the track is underperforming relative to other tracks. For example, relative performance values Pⱼₖ may be computed for various tracks. If the track is underperforming, e.g., if one or more other tracks perform better than a given track by a predetermined margin, the given track may be placed, at block 550, on the list of eliminated tracks. If the track is not underperforming, the track may be kept as an active track. At block 555, evaluation 520 may check if the evaluated track is the last active track and return to block 530 for evaluation of additional tracks that have not been evaluated yet. If all tracks have been evaluated, and it is determined, at block 560, that there is at least one active track remaining, training of the active tracks may be continued at block 515 using the next portion of the training data.

If it is determined, at block 560, that all tracks are inactive (stopped or eliminated) or if it is determined, at block 565, that the training data has been used up, a comparison of MLM performances may be performed at block 570 to select one or more winning tracks. The selection of the winning track(s) may be performed among various MLMs that have not been eliminated, e.g., among MLMs associated with stopped tracks and/or tracks that remained active through the end of training. Comparing the tracks may include processing a test data by the corresponding MLMs and selecting, at block 580, one or more winner MLMs. The winner MLMs may be determined based on any suitable metric, e.g., a number of correct classifications achieved for the test data, minimum aggregated or average loss during processing of the test data, and/or the like.

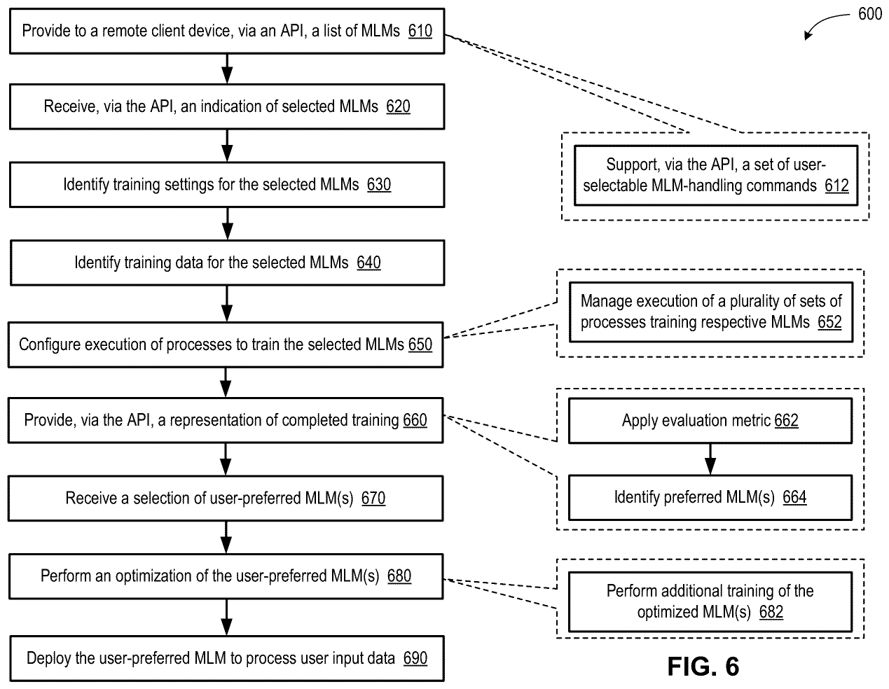

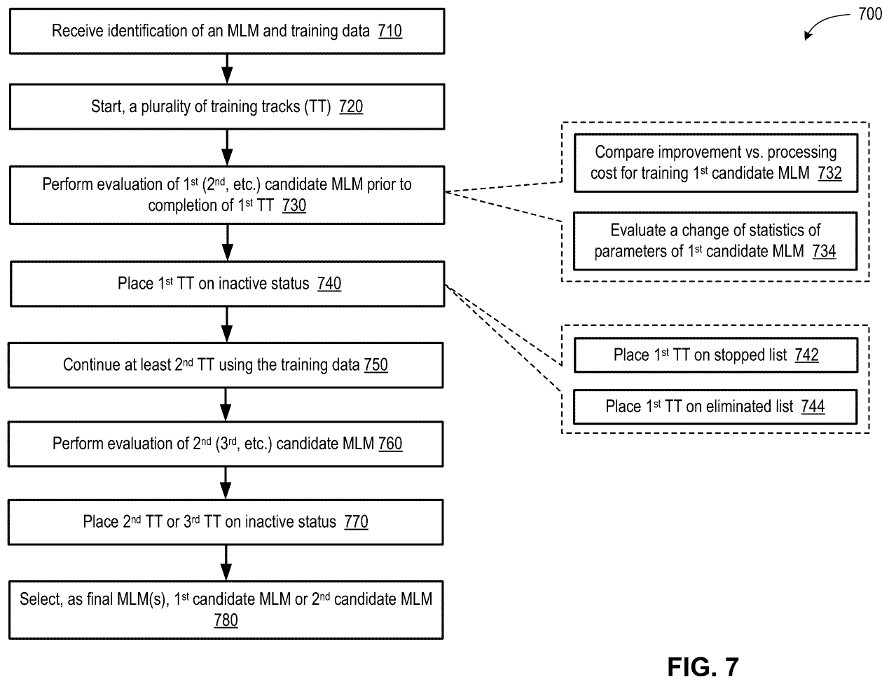

FIG. 6 and FIG. 7 are flow diagrams of example methods 600 and 700, respectively, that are related to training, adapting, optimizing, and deploying machine learning models, in accordance with at least some embodiments. Method 600 and/or method 700 may be performed to train and deploy MLMs for use in voice recognition, speech recognition, speech synthesis, object detection, object recognition, motion detection, hazard detection, robotics applications, forecasting, and many other contexts and applications where machine learning may be used. In at least one embodiment, method 600 and/or method 700 may be performed by processing units of MLI server 102 or processing units of some other computing device, or a combination of multiple computing devices. Method 600 and/or method 700 may be performed by one or more processing units (e.g., CPUs and/or GPUs), which may include (or communicate with) one or more memory devices. In at least one embodiment, method 600 and/or method 700 may be performed by multiple processing threads (e.g., CPU threads and/or GPU threads), each thread executing one or more individual functions, routines, subroutines, or operations of the method. In at least one embodiment, processing threads implementing method 600 and/or method 700 may be synchronized, e.g., using semaphores, critical sections, and/or other thread synchronization mechanisms. Alternatively, processing threads implementing method 600 and/or method 700 may be executed asynchronously with respect to each other. Various operations of method 600 and/or method 700 may be performed in a different order compared with the order shown in FIG. 6 and FIG. 7. Some operations of the methods may be performed concurrently with other operations. In at least one embodiment, one or more operations shown in FIG. 6 and/or FIG. 7 may not always be performed.

FIG. 6 is a flow diagram of an example method 600 of providing cloud-based services for training, adapting, optimizing, and deploying machine learning models, in accordance with at least some embodiments. Method 600 may be performed by processing units of a server (e.g., MLI server 102 of FIG. 1A or FIG. 2). At block 610, processing units performing method 600 may provide, to a remote client device, via an API (e.g., MLI API 104), a list of one or more available MLMs, which may include cloud-based (e.g., cloud-hosted and/or cloud-facilitated) MLMs and/or MLMs previously trained by the user. The list may be displayed on a user interface of the remote client device. As indicated with block 612, the API may support a set of user-selectable MLM-handling commands, which may include one or more of a TRAIN command, a PRUNE command, a QUANTIZE command, an EVALUATE command, an EXPORT command, an INFER command, or a data AUGMENTATION command.

At block 620, method 600 may continue with receiving, from the remote client device and via the API, an indication of one or more selected MLMs from the provided list of the one or more available MLMs. For example, the user may select the MLMs using a clickable menu, command line, as part of the parameters of the train command, and/or the like. At block 630, method 600 may include identifying training settings for the one or more selected MLMs. In some embodiments, the identified training settings may include stored (e.g., on the cloud-based MLI services) training settings, user-modified stored training settings, and/or user-generated training settings. The training settings may include training hyperparameters, e.g., learning rate, batch size, number of training epochs, and/or the like.

At block 640, method 600 may continue with identifying a training data for the selected MLMs. The training data may include data provided by the cloud services, user-specified data, or any combination thereof. The identification of the training data may include a memory location where the training data is stored, identification of sources (e.g., streaming devices) of the training data, and so on. At block 650, method 600 may include configuring, using the identified training settings, execution of one or more processes to train the one or more selected MLMs using the identified training data. For example, as illustrated with callout block 652, configuring the execution of the one or more processes may include managing execution of a plurality of sets of jobs on one or more processing devices. Individual sets of jobs may be instantiated to train respective MLMs of the one or more selected MLMs. For example, WFE 106 may instantiate a set of jobs to support training of various MLMs selected by the user (and/or other users of the cloud-based MLI service).

At block 660, method 600 may include providing to the remote client device, via the API, a representation of completed training of at least one MLM of the one or more selected MLMs, which may include one or more preferred MLMs. For example, as indicated with block 662, method 600 may include applying an evaluation metric to identify one or more preferred MLMs. At block 664, method 600 may include providing the representation of the one or more preferred MLMs to the remote client device.

At block 670, method 600 may include receiving, from the remote client device, a selection of a user-preferred MLM from the one or more preferred MLMs. In some instances, as indicated by block 680, method 600 may include performing an optimization of the user-preferred MLMs to generate an optimized MLM. Optimization of the one or more user-preferred MLM may include pruning of neurons of the user-preferred MLM(s), quantization of parameters of the user-preferred MLM(s), changing a format of numbers used by MLM(s), e.g., from a floating-point format to an integer format, and/or other optimization operations. As indicated with block 682, method 600 may include performing additional training of the optimized MLM.

At block 690, method 600 may continue with deploying the one or more user-preferred MLMs on user-accessible cloud-based hardware resources. The user-accessible cloud-based hardware resources may include one or more Graphics Processing Units (GPUs). Operations of block 690 may further include making the deployed user-preferred MLM(s) available to process user input data. In some embodiments, operations of block 690 may include receiving the user input data (which may be specified by the user via the MLI API) and causing the deployed user-preferred MLM(s) to be applied to the user input data to generate an output data. For example, the user may indicate the user-preferred MLM(s) and the user input data using API command INFER. In response to the INFER command, the MLI server may deploy one or more MLI frameworks to perform computations of the user-preferred MLM(s) and generate the output data. Method 600 may then continue with providing, to the remote client device, a representation of the output data, e.g., classification results, identification of an object in the input data (image), recognized text in a document, recognized speech in a sound file, identification of a manufacturing condition represented by industrial sensor data, and/or so on.

In some embodiments, method 600 may include protecting, from unauthorized access, the one or more selected MLMs, the training setting for the one or more selected MLMs, the training data, the user input data, the representation of the output data, and/or the like.

FIG. 7 is a flow diagram of an example method 700 of training machine learning models using experiment-based early stopping techniques, in accordance with at least some embodiments. In some embodiments, method 700 may be used in conjunction with method 600. In some embodiments, method 700 may be used independently from method 600. At block 710, the processing units performing method 700 may identify an MLM to be trained and a training data for training of the MLM. Although, for brevity and conciseness, a reference is made to a single MLM, method 700 may be used to train multiple MLMs. The training data may include any number of units of training data, e.g., images, video and/or sound recordings, texts, speech utterances, batches of sensor data, and/or the like. In some embodiments, the processing units may identify the MLM and/or the training data responsive to commands from a user (e.g., as parameters of a TRAIN command).

At block 720, method 700 may continue with the processing units starting a plurality of training tracks (TT). Individual TTs of the plurality of TTs may train respective candidate MLMs. Different tracks may use the same training data and different sets of training settings. The training settings may include various training hyperparameters. At block 730, method 700 may continue with performing a first evaluation of a first candidate MLM (e.g., the candidate being trained by the first TT). The evaluation may be performed prior to completion of the first TT, e.g., prior to using all training data or prior to reaching any pre-determined completion marker (e.g., number of training epochs, total training time, etc.). As indicated by the top callout portion of FIG. 7, performing the first evaluation of the first candidate MLM may include a number of different operations. For example, as illustrated with block 732, such operations may include comparing an improvement of the first candidate MLM over one or more training epochs (or training units) to a processing cost of training of the first candidate MLM over the one or more training epochs. The improvement vs. cost comparison may involve determining the improvement and the cost for the training epoch(s) already competed. In some embodiments, the improvement vs. cost comparison may involve projecting the improvement and the cost for the future training epoch(s), and/or for some combination thereof. In some embodiments, as illustrated by block 734, performing the first evaluation may include evaluating a change of statistics of parameters (e.g., weights and/or biases) of the first candidate MLM over one or more training epochs. The first evaluation may also be performed for a second (third, etc.) candidate MLMs, e.g., for all active candidate MLMs.

At block 740, method 700 may continue with placing, responsive to the first evaluation, the first TT on an inactive status indicating that further training of the candidate MLM is to be ceased. As illustrated with block 742 of the bottom callout portion of FIG. 7, placing the first TT on the inactive status may include placing the first TT on a stopped list. Placement of a TT on the stopped list may indicate that even though the training of the corresponding (e.g., first, second, etc.) candidate MLM is to ceased, the candidate MLM is still to be included into a pool of MLMs from which the one or more final MLMs are selected. Placing the first (second, etc.) TT on the stopped list may be responsive to the first evaluation (or further evaluations) determining that an improvement of the first candidate MLM over one or more training epochs is below a threshold value.

As illustrated with block 744, placing the first TT on the inactive status may include placing the first TT on an eliminated list. Placement of a TT on the eliminated list may indicate that the corresponding (e.g., first, second, etc.) candidate MLM is to be excluded from the pool of MLMs from which the one or more final MLMs are selected. In some embodiments, placing the first (second, third, etc.) TT on the eliminated list is responsive to the first evaluation determining that accuracy of the first candidate MLM is below accuracy of the second candidate MLM, below accuracy of a third candidate MLM, and/or below accuracy of at least one other candidate MLM. In some embodiments, to be placed on the eliminated list, the first candidate MLM is to have accuracy that is below accuracy of at least one other candidate (e.g., first candidate, second candidate, etc.) by at least a threshold amount. Accuracy of various candidate MLMs may be quantified by applying any suitable loss function to outputs of the respective candidate MLMs obtained by processing the same inputs.

At block 750, method 700 may continue at least a second TT of the plurality of TTs over additional training epochs. The second TT may be continued using the training data, e.g., using previously unseen portions of the training data. In some embodiments, continuing the second TT may be responsive to the first evaluation determining that an improvement of the second candidate MLM over one or more training epochs is above a threshold value.

At block 760, method 700 may include performing a second (third, etc.) evaluation of the second candidate MLM and a third candidate MLM of the plurality of candidate MLMs. The second evaluation may also evaluate other remaining active TTs. At block 770, method 700 may continue with placing, responsive to the second evaluation, at least one of the second TT or a third TT of the plurality of TTs on the inactive status. At block 780, method 700 may include selecting, responsive to conclusion of the plurality of TTs, as one or more final MLMs. Conclusion of the plurality of TTs may occur when the TTs are stopped, eliminated, or completed (e.g., when the training data has been used up or when any predetermined completion marker has been reached). Conclusion of the plurality of TTs may also occur upon receiving a stopping command from the user. The one or more final MLMs may be selected from stopped but not eliminated TTs, (which may include, e.g., the first candidate MLM), or from completed TTs (which may include, e.g., the second or the third, or other, candidate MLMs). Selection of the one or more final MLMs may be performed based on accuracy of the remaining (not eliminated) candidate MLMs determined using a test data.

### Inference and Training Logic

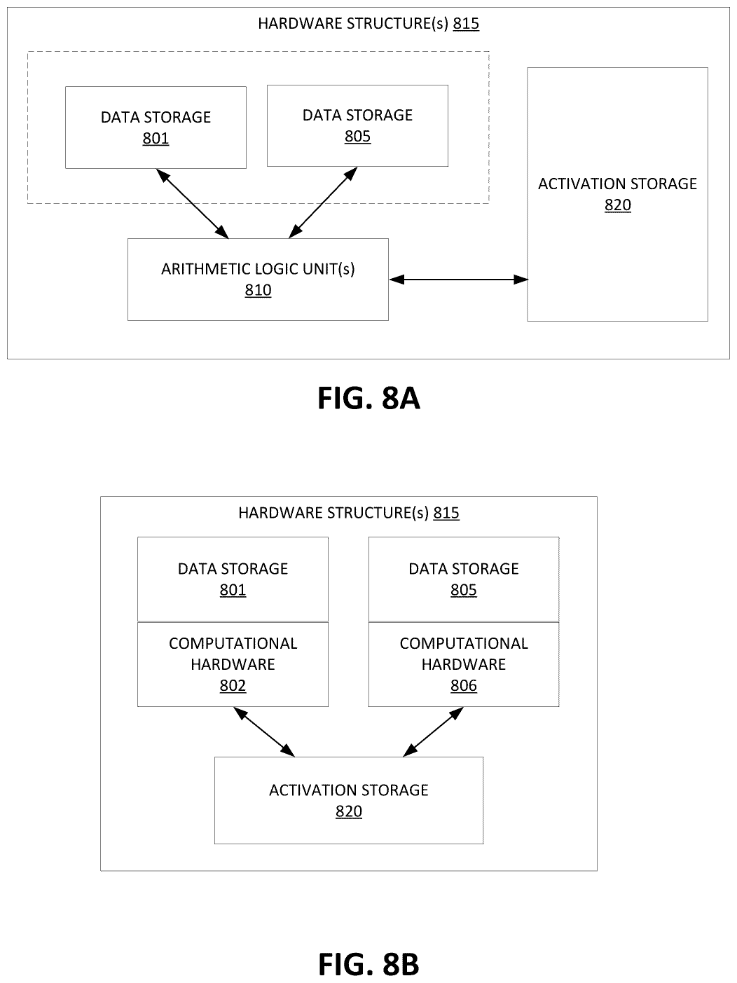

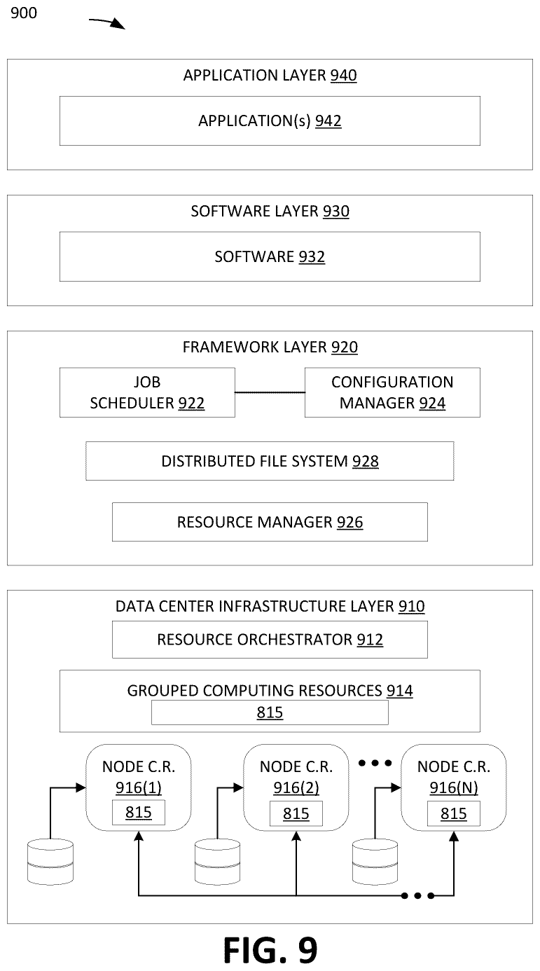

FIG. 8A illustrates inference and/or training logic 815 used to perform inferencing and/or training operations associated with one or more embodiments. Details regarding inference and/or training logic 815 are provided below in conjunction with FIGS. 8A and/or 8B.

In at least one embodiment, inference and/or training logic 815 may include, without limitation, code and/or data storage 801 to store forward and/or output weight and/or input/output data, and/or other parameters to configure neurons or layers of a neural network trained and/or used for inferencing in aspects of one or more embodiments. In at least one embodiment, training logic 815 may include, or be coupled to code and/or data storage 801 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 801 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 801 may be included with other on-chip or off-chip data storage, including a processor's L1, L2, or L3 cache or system memory.

In at least one embodiment, any portion of code and/or data storage 801 may be internal or external to one or more processors or other hardware logic devices or circuits. In at least one embodiment, code and/or code and/or data storage 801 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 801 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 815 may include, without limitation, a code and/or data storage 805 to store backward and/or output weight and/or input/output data corresponding to neurons or layers of a neural network trained and/or used for inferencing in aspects of one or more embodiments. In at least one embodiment, code and/or data storage 805 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 815 may include, or be coupled to code and/or data storage 805 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 805 may be included with other on-chip or off-chip data storage, including a processor's L1, L2, or L3 cache or system memory. In at least one embodiment, any portion of code and/or data storage 805 may be internal or external to on one or more processors or other hardware logic devices or circuits. In at least one embodiment, code and/or data storage 805 may be cache memory, DRAM, SRAM, non-volatile memory (e.g., Flash memory), or other storage. In at least one embodiment, choice of whether code and/or data storage 805 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 801 and code and/or data storage 805 may be separate storage structures. In at least one embodiment, code and/or data storage 801 and code and/or data storage 805 may be same storage structure. In at least one embodiment, code and/or data storage 801 and code and/or data storage 805 may be partially same storage structure and partially separate storage structures. In at least one embodiment, any portion of code and/or data storage 801 and code and/or data storage 805 may be included with other on-chip or off-chip data storage, including a processor's L1, L2, or L3 cache or system memory.

In at least one embodiment, inference and/or training logic 815 may include, without limitation, one or more arithmetic logic unit(s) (“ALU(s)”) 810, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 820 that are functions of input/output and/or weight parameter data stored in code and/or data storage 801 and/or code and/or data storage 805. In at least one embodiment, activations stored in activation storage 820 are generated according to linear algebraic and or matrix-based mathematics performed by ALU(s) 810 in response to performing instructions or other code, wherein weight values stored in code and/or data storage 805 and/or code and/or data storage 801 are used as operands along with other values, such as bias values, gradient information, momentum values, or other parameters or hyperparameters, any or all of which may be stored in code and/or data storage 805 or code and/or data storage 801 or another storage on or off-chip.

In at least one embodiment, ALU(s) 810 are included within one or more processors or other hardware logic devices or circuits, whereas in another embodiment, ALU(s) 810 may be external to a processor or other hardware logic device or circuit that uses them (e.g., a co-processor). In at least one embodiment, ALUs 810 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 801, code and/or data storage 805, and activation storage 820 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 820 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 820 may be cache memory, DRAM, SRAM, non-volatile memory (e.g., Flash memory), or other storage. In at least one embodiment, activation storage 820 may be completely or partially within or external to one or more processors or other logical circuits. In at least one embodiment, choice of whether activation storage 820 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 815 illustrated in FIG. 8A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8A may be used in conjunction with central processing unit (“CPU”) hardware, graphics processing unit (“GPU”) hardware or other hardware, such as data processing unit (“DPU”) hardware, or field programmable gate arrays (“FPGAs”).

FIG. 8B illustrates inference and/or training logic 815, according to at least one or more embodiments. In at least one embodiment, inference and/or training logic 815 may include, without limitation, hardware logic in which computational resources are dedicated or otherwise exclusively used in conjunction with weight values or other information corresponding to one or more layers of neurons within a neural network. In at least one embodiment, inference and/or training logic 815 illustrated in FIG. 8B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8B may be used in conjunction with central processing unit (CPU) hardware, graphics processing unit (GPU) hardware or other hardware, such as data processing unit (“DPU”) hardware, or field programmable gate arrays (FPGAs). In at least one embodiment, inference and/or training logic 815 includes, without limitation, code and/or data storage 801 and code and/or data storage 805, which may be used to store code (e.g., graph code), weight values and/or other information, including bias values, gradient information, momentum values, and/or other parameter or hyperparameter information. In at least one embodiment illustrated in FIG. 8B, each of code and/or data storage 801 and code and/or data storage 805 is associated with a dedicated computational resource, such as computational hardware 802 and computational hardware 806, respectively. In at least one embodiment, each of computational hardware 802 and computational hardware 806 comprises one or more ALUs that perform mathematical functions, such as linear algebraic functions, only on information stored in code and/or data storage 801 and code and/or data storage 805, respectively, result of which is stored in activation storage 820.

In at least one embodiment, each of code and/or data storage 801 and 805 and corresponding computational hardware 802 and 806, respectively, correspond to different layers of a neural network, such that resulting activation from one “storage/computational pair 801/802” of code and/or data storage 801 and computational hardware 802 is provided as an input to “storage/computational pair 805/806” of code and/or data storage 805 and computational hardware 806, in order to mirror conceptual organization of a neural network. In at least one embodiment, each of storage/computational pairs 801/802 and 805/806 may correspond to more than one neural network layer. In at least one embodiment, additional storage/computation pairs (not shown) subsequent to or in parallel with storage computation pairs 801/802 and 805/806 may be included in inference and/or training logic 815.

### Data Center

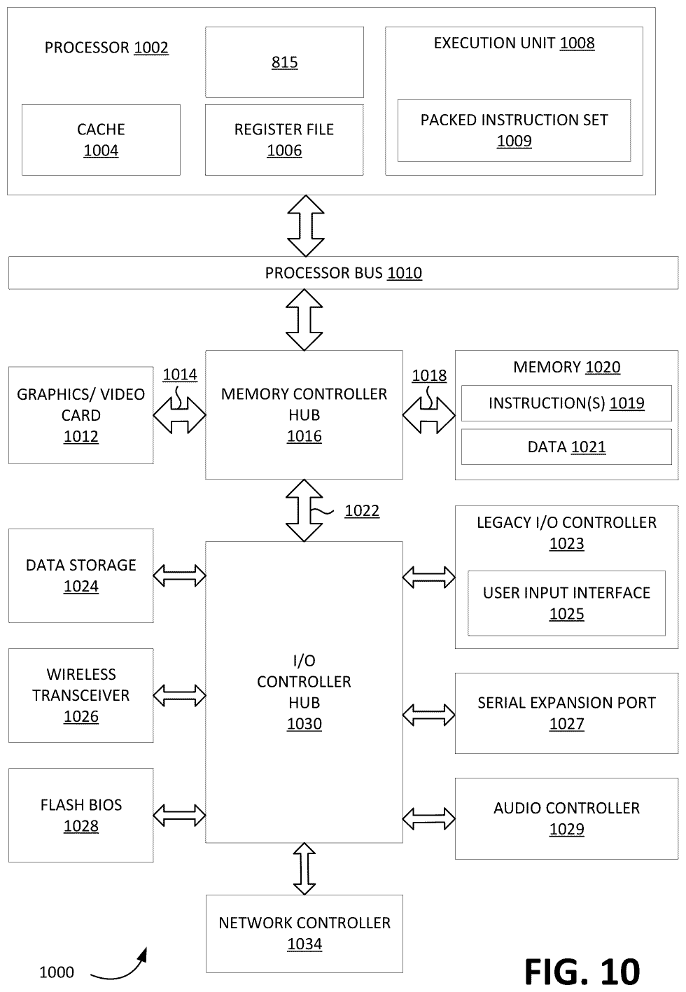

FIG. 9 illustrates an example data center 900, in which at least one embodiment may be used. In at least one embodiment, data center 900 includes a data center infrastructure layer 910, a framework layer 920, a software layer 930, and an application layer 940.

In at least one embodiment, as shown in FIG. 9, data center infrastructure layer 910 may include a resource orchestrator 912, grouped computing resources 914, and node computing resources (“node C.R.s”) 916(1)-1016(N), where “N” represents any whole, positive integer. In at least one embodiment, node C.R.s 916(1)-1016(N) may include, but are not limited to, any number of central processing units (“CPUs”) or other processors (including accelerators, field programmable gate arrays (FPGAs), data processing units, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-1016(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 912 may configure or otherwise control one or more node C.R.s 916(1)-1016(N) and/or grouped computing resources 914. In at least one embodiment, resource orchestrator 912 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 922, a configuration manager 924, a resource manager 926 and a distributed file system 928. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 928 for large-scale data processing (e.g., “big data”). In at least one embodiment, job scheduler 922 may include a Spark driver to facilitate scheduling of workloads supported by various layers of data center 900. In at least one embodiment, configuration manager 924 may be capable of configuring different layers such as software layer 930 and framework layer 920 including Spark and distributed file system 928 for supporting large-scale data processing. In at least one embodiment, resource manager 926 may be capable of managing clustered or grouped computing resources mapped to or allocated for support of distributed file system 928 and job scheduler 922. In at least one embodiment, clustered or grouped computing resources may include grouped computing resource 914 at data center infrastructure layer 910. In at least one embodiment, resource manager 926 may coordinate with resource orchestrator 912 to manage these mapped or allocated computing resources.

In at least one embodiment, software 932 included in software layer 930 may include software used by at least portions of node C.R.s 916(1)-1016(N), grouped computing resources 914, and/or distributed file system 928 of framework layer 920. The one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-1016(N), grouped computing resources 914, and/or distributed file system 928 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 924, resource manager 926, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, DPUs FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 815 are used to perform inferencing and/or training operations associated with one or more embodiments. Details regarding inference and/or training logic 815 are provided below in conjunction with FIGS. 8A and/or 8B. In at least one embodiment, inference and/or training logic 815 may be used in system FIG. 9 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

### Computer Systems

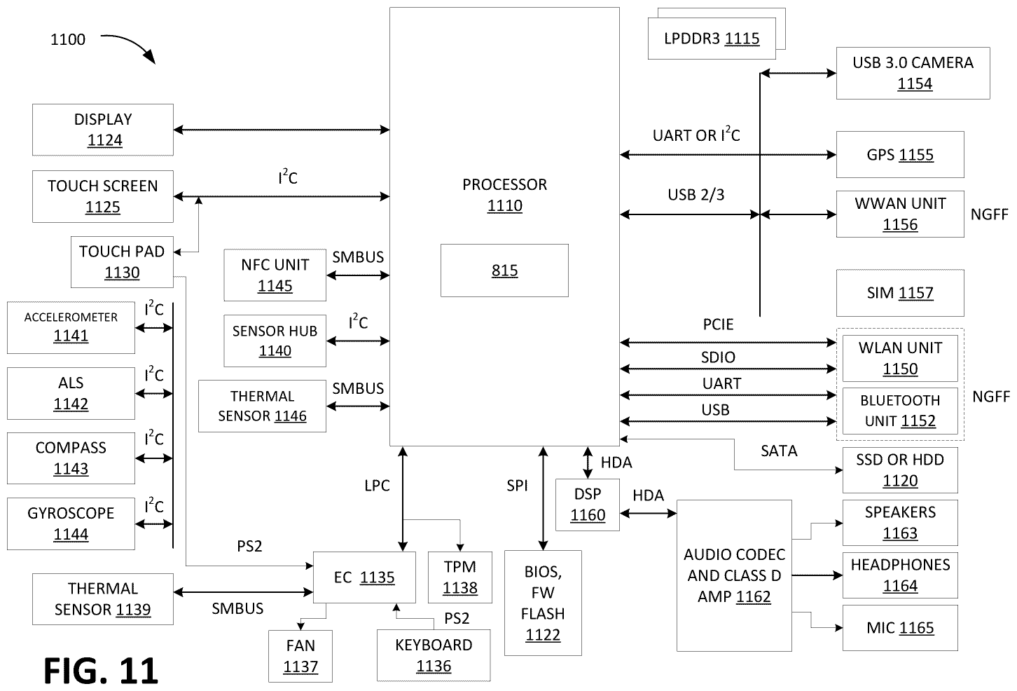

FIG. 10 is a block diagram illustrating an exemplary computer system, which may be a system with interconnected devices and components, a system-on-a-chip (SOC) or some combination thereof 1000 formed with a processor that may include execution units to execute an instruction, according to at least one embodiment. In at least one embodiment, computer system 1000 may include, without limitation, a component, such as a processor 1002 to employ execution units including logic to perform algorithms for process data, in accordance with present disclosure, such as in embodiment described herein. In at least one embodiment, computer system 1000 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1000 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 1000 may include, without limitation, processor 1002 that may include, without limitation, one or more execution units 1008 to perform machine learning model training and/or inferencing according to techniques described herein. In at least one embodiment, computer system 1000 is a single processor desktop or server system, but in another embodiment computer system 1000 may be a multiprocessor system. In at least one embodiment, processor 1002 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 1002 may be coupled to a processor bus 1010 that may transmit data signals between processor 1002 and other components in computer system 1000.

In at least one embodiment, processor 1002 may include, without limitation, a Level 1 (“L1”) internal cache memory (“cache”) 1004. In at least one embodiment, processor 1002 may have a single internal cache or multiple levels of internal cache. In at least one embodiment, cache memory may reside external to processor 1002. Other embodiments may also include a combination of both internal and external caches depending on particular implementation and needs. In at least one embodiment, register file 1006 may store different types of data in various registers including, without limitation, integer registers, floating point registers, status registers, and instruction pointer register.

In at least one embodiment, execution unit 1008, including, without limitation, logic to perform integer and floating point operations, also resides in processor 1002. In at least one embodiment, processor 1002 may also include a microcode (“ucode”) read only memory (“ROM”) that stores microcode for certain macro instructions. In at least one embodiment, execution unit 1008 may include logic to handle a packed instruction set 1009. In at least one embodiment, by including packed instruction set 1009 in an instruction set of a general-purpose processor 1002, along with associated circuitry to execute instructions, operations used by many multimedia applications may be performed using packed data in a general-purpose processor 1002. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 1008 may also be used in microcontrollers, embedded processors, graphics devices, DSPs, and other types of logic circuits. In at least one embodiment, computer system 1000 may include, without limitation, a memory 1020. In at least one embodiment, memory 1020 may be implemented as a Dynamic Random Access Memory (“DRAM”) device, a Static Random Access Memory (“SRAM”) device, flash memory device, or other memory device. In at least one embodiment, memory 1020 may store instruction(s) 1019 and/or data 1021 represented by data signals that may be executed by processor 1002.

In at least one embodiment, system logic chip may be coupled to processor bus 1010 and memory 1020. In at least one embodiment, system logic chip may include, without limitation, a memory controller hub (“MCH”) 1016, and processor 1002 may communicate with MCH 1016 via processor bus 1010. In at least one embodiment, MCH 1016 may provide a high bandwidth memory path 1018 to memory 1020 for instruction and data storage and for storage of graphics commands, data and textures. In at least one embodiment, MCH 1016 may direct data signals between processor 1002, memory 1020, and other components in computer system 1000 and to bridge data signals between processor bus 1010, memory 1020, and a system I/O 1022. In at least one embodiment, system logic chip may provide a graphics port for coupling to a graphics controller. In at least one embodiment, MCH 1016 may be coupled to memory 1020 through a high bandwidth memory path 1018 and graphics/video card 1012 may be coupled to MCH 1016 through an Accelerated Graphics Port (“AGP”) interconnect 1014.

In at least one embodiment, computer system 1000 may use system I/O 1022 that is a proprietary hub interface bus to couple MCH 1016 to I/O controller hub (“ICH”) 1030. In at least one embodiment, ICH 1030 may provide direct connections to some I/O devices via a local I/O bus. In at least one embodiment, local I/O bus may include, without limitation, a high-speed I/O bus for connecting peripherals to memory 1020, chipset, and processor 1002. Examples may include, without limitation, an audio controller 1029, a firmware hub (“flash BIOS”) 1028, a wireless transceiver 1026, a data storage 1024, a legacy I/O controller 1023 containing user input and keyboard interfaces 1025, a serial expansion port 1027, such as Universal Serial Bus (“USB”), and a network controller 1034, which may include in some embodiments, a data processing unit. Data storage 1024 may comprise a hard disk drive, a floppy disk drive, a CD-ROM device, a flash memory device, or other mass storage device.

In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 1000 are interconnected using compute express link (CXL) interconnects.

Inference and/or training logic 815 are used to perform inferencing and/or training operations associated with one or more embodiments. Details regarding inference and/or training logic 815 are provided below in conjunction with FIGS. 8A and/or 8B. In at least one embodiment, inference and/or training logic 815 may be used in system FIG. 10 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

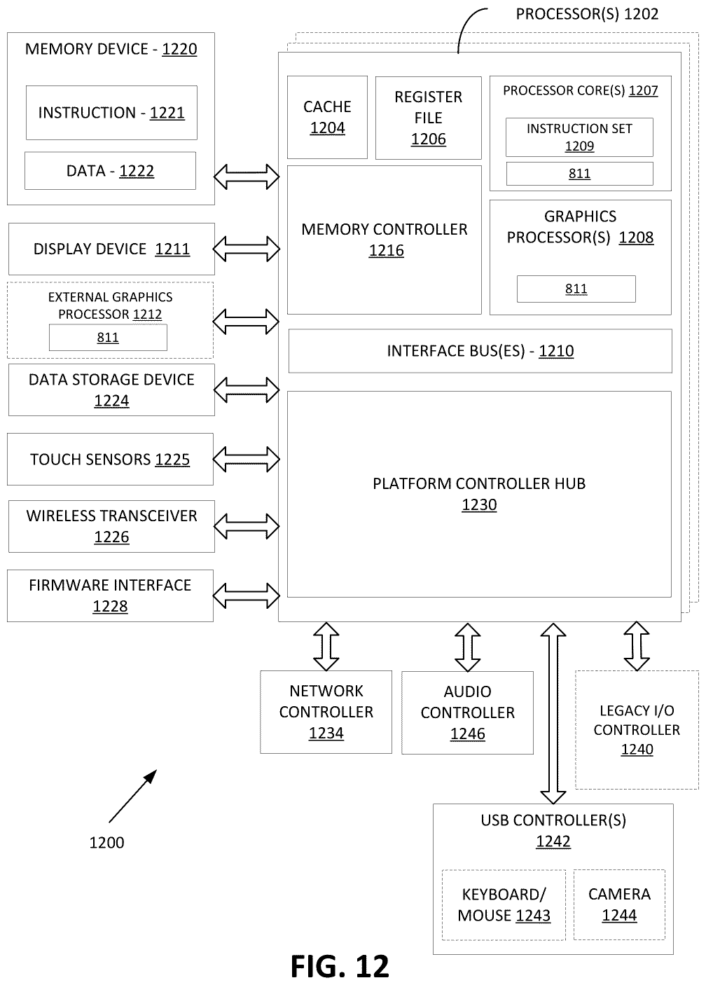

FIG. 11 is a block diagram illustrating an electronic device 1100 for utilizing a processor 1110, according to at least one embodiment. In at least one embodiment, electronic device 1100 may be, for example and without limitation, a notebook, a tower server, a rack server, a blade server, a laptop, a desktop, a tablet, a mobile device, a phone, an embedded computer, an edge device, an IoT device, or any other suitable electronic device.

In at least one embodiment, electronic device 1100 may include, without limitation, processor 1110 communicatively coupled to any suitable number or kind of components, peripherals, modules, or devices. In at least one embodiment, processor 1110 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 11 illustrates a system, which includes interconnected hardware devices or “chips”, whereas in other embodiments, FIG. 11 may illustrate an exemplary System on a Chip (“SoC”). In at least one embodiment, devices illustrated in FIG. 11 may be interconnected with proprietary interconnects, standardized interconnects (e.g., PCIe) or some combination thereof. In at least one embodiment, one or more components of FIG. 11 are interconnected using compute express link (CXL) interconnects.

In at least one embodiment, FIG. 11 may include a display 1124, a touch screen 1125, a touch pad 1130, a Near Field Communications unit (“NFC”) 1145, a sensor hub 1140, a thermal sensor 1146, an Express Chipset (“EC”) 1135, a Trusted Platform Module (“TPM”) 1138, BIOS/firmware/flash memory (“BIOS, FW Flash”) 1122, a DSP 1160, a drive 1120 such as a Solid State Disk (“SSD”) or a Hard Disk Drive (“HDD”), a wireless local area network unit (“WLAN”) 1150, a Bluetooth unit 1152, a Wireless Wide Area Network unit (“WWAN”) 1156, a Global Positioning System (GPS) 1155, a camera (“USB 3.0 camera”) 1154 such as a USB 3.0 camera, and/or a Low Power Double Data Rate (“LPDDR”) memory unit (“LPDDR3”) 1115 implemented in, for example, LPDDR3 standard. These components may each be implemented in any suitable manner.

In at least one embodiment, other components may be communicatively coupled to processor 1110 through components discussed above. In at least one embodiment, an accelerometer 1141, Ambient Light Sensor (“ALS”) 1142, compass 1143, and a gyroscope 1144 may be communicatively coupled to sensor hub 1140. In at least one embodiment, thermal sensor 1139, a fan 1137, a keyboard 1136, and a touch pad 1130 may be communicatively coupled to EC 1135. In at least one embodiment, speaker 1163, audio unit (e.g., headphones) 1164, and microphone (“mic”) 1165 may be communicatively coupled to an audio unit (“audio codec and class d amp”) 1162, which may in turn be communicatively coupled to DSP 1160. In at least one embodiment, audio unit 1164 may include, for example and without limitation, an audio coder/decoder (“codec”) and a class D amplifier. In at least one embodiment, SIM card (“SIM”) 1157 may be communicatively coupled to WWAN unit 1156. In at least one embodiment, components such as WLAN unit 1150 and Bluetooth unit 1152, as well as WWAN unit 1156 may be implemented in a Next Generation Form Factor (“NGFF”).

Inference and/or training logic 815 are used to perform inferencing and/or training operations associated with one or more embodiments. Details regarding inference and/or training logic 815 are provided below in conjunction with FIGS. 8A and/or 8B. In at least one embodiment, inference and/or training logic 815 may be used in system FIG. 11 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

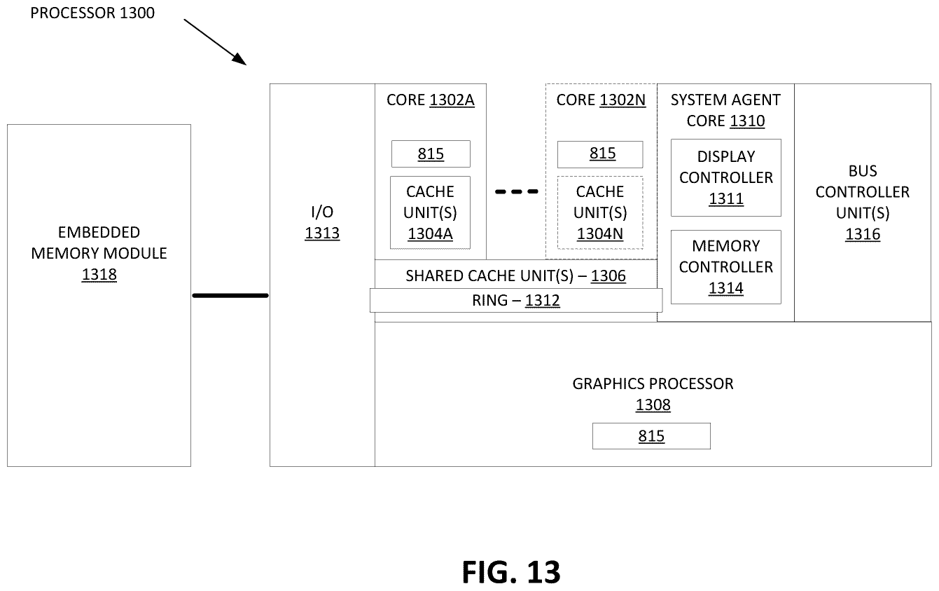

FIG. 12 is a block diagram of a processing system, according to at least one embodiment. In at least one embodiment, system 1200 includes one or more processors 1202 and one or more graphics processors 1208, and may be a single processor desktop system, a multiprocessor workstation system, or a server system having a large number of processors 1202 or processor cores 1207. In at least one embodiment, system 1200 is a processing platform incorporated within a system-on-a-chip (SoC) integrated circuit for use in mobile, handheld, edge, or embedded devices.

In at least one embodiment, system 1200 may include, or be incorporated within a server-based gaming platform, a game console, including a game and media console, a mobile gaming console, a handheld game console, or an online game console. In at least one embodiment, system 1200 is a mobile phone, smart phone, tablet computing device or mobile Internet device. In at least one embodiment, processing system 1200 may also include, couple with, or be integrated within a wearable device, such as a smart watch wearable device, smart eyewear device, augmented reality device, or virtual reality device. In at least one embodiment, processing system 1200 is a television or set top box device having one or more processors 1202 and a graphical interface generated by one or more graphics processors 1208.

In at least one embodiment, one or more processors 1202 each include one or more processor cores 1207 to process instructions which, when executed, perform operations for system and user software. In at least one embodiment, each of one or more processor cores 1207 is configured to process a specific instruction set 1209. In at least one embodiment, instruction set 1209 may facilitate Complex Instruction Set Computing (CISC), Reduced Instruction Set Computing (RISC), or computing via a Very Long Instruction Word (VLIW). In at least one embodiment, processor cores 1207 may each process a different instruction set 1209, which may include instructions to facilitate emulation of other instruction sets. In at least one embodiment, processor core 1207 may also include other processing devices, such a Digital Signal Processor (DSP).

In at least one embodiment, processor 1202 includes cache memory 1204. In at least one embodiment, processor 1202 may have a single internal cache or multiple levels of internal cache. In at least one embodiment, cache memory is shared among various components of processor 1202. In at least one embodiment, processor 1202 also uses an external cache (e.g., a Level-3 (L3) cache or Last Level Cache (LLC)) (not shown), which may be shared among processor cores 1207 using known cache coherency techniques. In at least one embodiment, register file 1206 is additionally included in processor 1202 which may include different types of registers for storing different types of data (e.g., integer registers, floating point registers, status registers, and an instruction pointer register). In at least one embodiment, register file 1206 may include general-purpose registers or other registers.

In at least one embodiment, one or more processor(s) 1202 are coupled with one or more interface bus(es) 1210 to transmit communication signals such as address, data, or control signals between processor 1202 and other components in system 1200. In at least one embodiment, interface bus 1210, in one embodiment, may be a processor bus, such as a version of a Direct Media Interface (DMI) bus. In at least one embodiment, interface 1210 is not limited to a DMI bus, and may include one or more Peripheral Component Interconnect buses (e.g., PCI, PCI Express), memory busses, or other types of interface busses. In at least one embodiment processor(s) 1202 include an integrated memory controller 1216 and a platform controller hub 1230. In at least one embodiment, memory controller 1216 facilitates communication between a memory device and other components of system 1200, while platform controller hub (PCH) 1230 provides connections to I/O devices via a local I/O bus.

In at least one embodiment, memory device 1220 may be a dynamic random access memory (DRAM) device, a static random access memory (SRAM) device, flash memory device, phase-change memory device, or some other memory device having suitable performance to serve as process memory. In at least one embodiment memory device 1220 may operate as system memory for system 1200, to store data 1222 and instructions 1221 for use when one or more processors 1202 executes an application or process. In at least one embodiment, memory controller 1216 also couples with an optional external graphics processor 1212, which may communicate with one or more graphics processors 1208 in processors 1202 to perform graphics and media operations. In at least one embodiment, a display device 1211 may connect to processor(s) 1202. In at least one embodiment display device 1211 may include one or more of an internal display device, as in a mobile electronic device or a laptop device or an external display device attached via a display interface (e.g., DisplayPort, etc.). In at least one embodiment, display device 1211 may include a head mounted display (HMD) such as a stereoscopic display device for use in virtual reality (VR) applications or augmented reality (AR) applications.

In at least one embodiment, platform controller hub 1230 enables peripherals to connect to memory device 1220 and processor 1202 via a high-speed I/O bus. In at least one embodiment, I/O peripherals include, but are not limited to, an audio controller 1246, a network controller 1234, a firmware interface 1228, a wireless transceiver 1226, touch sensors 1225, a data storage device 1224 (e.g., hard disk drive, flash memory, etc.). In at least one embodiment, data storage device 1224 may connect via a storage interface (e.g., SATA) or via a peripheral bus, such as a Peripheral Component Interconnect bus (e.g., PCI, PCI Express). In at least one embodiment, touch sensors 1225 may include touch screen sensors, pressure sensors, or fingerprint sensors. In at least one embodiment, wireless transceiver 1226 may be a Wi-Fi transceiver, a Bluetooth transceiver, or a mobile network transceiver such as a 3G, 4G, or Long Term Evolution (LTE) transceiver. In at least one embodiment, firmware interface 1228 enables communication with system firmware, and may be, for example, a unified extensible firmware interface (UEFI). In at least one embodiment, network controller 1234 may enable a network connection to a wired network. In at least one embodiment, a high-performance network controller (not shown) couples with interface bus 1210. In at least one embodiment, audio controller 1246 is a multi-channel high definition audio controller. In at least one embodiment, system 1200 includes an optional legacy I/O controller 1240 for coupling legacy (e.g., Personal System 2 (PS/2)) devices to system. In at least one embodiment, platform controller hub 1230 may also connect to one or more Universal Serial Bus (USB) controllers 1242 connect input devices, such as keyboard and mouse 1243 combinations, a camera 1244, or other USB input devices.

In at least one embodiment, an instance of memory controller 1216 and platform controller hub 1230 may be integrated into a discreet external graphics processor, such as external graphics processor 1212. In at least one embodiment, platform controller hub 1230 and/or memory controller 1216 may be external to one or more processor(s) 1202. For example, in at least one embodiment, system 1200 may include an external memory controller 1216 and platform controller hub 1230, which may be configured as a memory controller hub and peripheral controller hub within a system chipset that is in communication with processor(s) 1202.

Inference and/or training logic 815 are used to perform inferencing and/or training operations associated with one or more embodiments. Details regarding inference and/or training logic 815 are provided below in conjunction with FIGS. 8A and/or 8B. In at least one embodiment portions or all of inference and/or training logic 815 may be incorporated into graphics processor 1300. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIG. 8A or 8B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

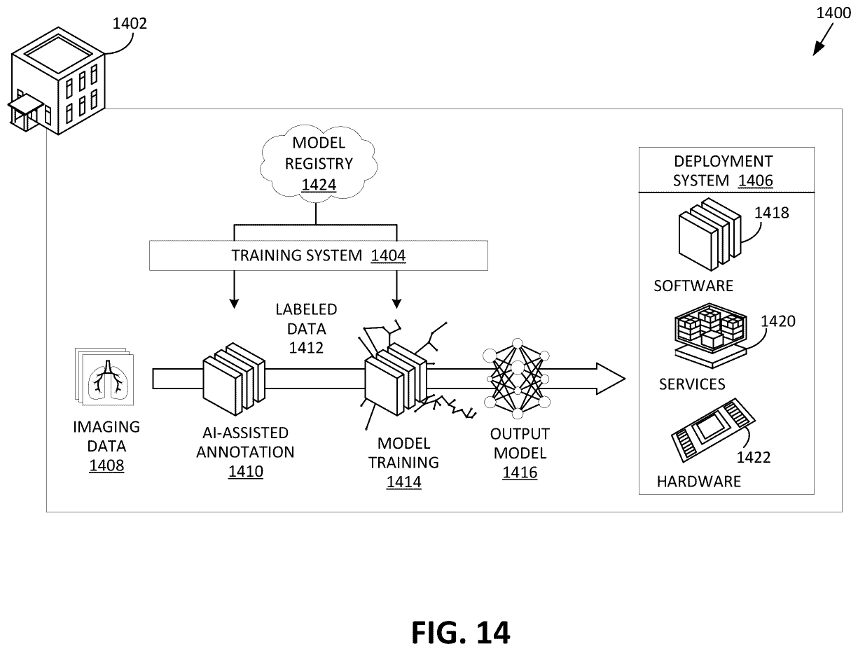

FIG. 13 is a block diagram of a processor 1300 having one or more processor cores 1302A-1402N, an integrated memory controller 1314, and an integrated graphics processor 1308, according to at least one embodiment. In at least one embodiment, processor 1300 may include additional cores up to and including additional core 1302N represented by dashed lined boxes. In at least one embodiment, each of processor cores 1302A-1402N includes one or more internal cache units 1304A-1404N. In at least one embodiment, each processor core also has access to one or more shared cached units 1306.

In at least one embodiment, internal cache units 1304A-1404N and shared cache units 1306 represent a cache memory hierarchy within processor 1300. In at least one embodiment, cache memory units 1304A-1404N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1306 and 1304A-1404N.

In at least one embodiment, processor 1300 may also include a set of one or more bus controller units 1316 and a system agent core 1310. In at least one embodiment, one or more bus controller units 1316 manage a set of peripheral buses, such as one or more PCI or PCI express busses. In at least one embodiment, system agent core 1310 provides management functionality for various processor components. In at least one embodiment, system agent core 1310 includes one or more integrated memory controllers 1314 to manage access to various external memory devices (not shown).

In at least one embodiment, one or more of processor cores 1302A-1402N include support for simultaneous multi-threading. In at least one embodiment, system agent core 1310 includes components for coordinating and operating cores 1302A-1402N during multi-threaded processing. In at least one embodiment, system agent core 1310 may additionally include a power control unit (PCU), which includes logic and components to regulate one or more power states of processor cores 1302A-1402N and graphics processor 1308.

In at least one embodiment, processor 1300 additionally includes graphics processor 1308 to execute graphics processing operations. In at least one embodiment, graphics processor 1308 couples with shared cache units 1306, and system agent core 1310, including one or more integrated memory controllers 1314. In at least one embodiment, system agent core 1310 also includes a display controller 1311 to drive graphics processor output to one or more coupled displays. In at least one embodiment, display controller 1311 may also be a separate module coupled with graphics processor 1308 via at least one interconnect, or may be integrated within graphics processor 1308.

In at least one embodiment, a ring based interconnect unit 1312 is used to couple internal components of processor 1300. In at least one embodiment, an alternative interconnect unit may be used, such as a point-to-point interconnect, a switched interconnect, or other techniques. In at least one embodiment, graphics processor 1308 couples with ring interconnect 1312 via an I/O link 1313.

In at least one embodiment, I/O link 1313 represents at least one of multiple varieties of I/O interconnects, including an on package I/O interconnect which facilitates communication between various processor components and a high-performance embedded memory module 1318, such as an eDRAM module. In at least one embodiment, each of processor cores 1302A-1402N and graphics processor 1308 use embedded memory modules 1318 as a shared Last Level Cache.

In at least one embodiment, processor cores 1302A-1402N are homogenous cores executing a common instruction set architecture. In at least one embodiment, processor cores 1302A-1402N are heterogeneous in terms of instruction set architecture (ISA), where one or more of processor cores 1302A-1402N execute a common instruction set, while one or more other cores of processor cores 1302A-1402N executes a subset of a common instruction set or a different instruction set. In at least one embodiment, processor cores 1302A-1402N are heterogeneous in terms of microarchitecture, where one or more cores having a relatively higher power consumption couple with one or more power cores having a lower power consumption. In at least one embodiment, processor 1300 may be implemented on one or more chips or as an SoC integrated circuit.

Inference and/or training logic 815 are used to perform inferencing and/or training operations associated with one or more embodiments. Details regarding inference and/or training logic 815 are provided below in conjunction with FIGS. 8A and/or 8B. In at least one embodiment portions or all of inference and/or training logic 815 may be incorporated into processor 1300. For example, in at least one embodiment, training and/or inferencing techniques described herein may use one or more of ALUs embodied in graphics processor 1308, graphics core(s) 1302A-1402N, or other components in FIG. 13. Moreover, in at least one embodiment, inferencing and/or training operations described herein may be done using logic other than logic illustrated in FIG. 8A or 8B. In at least one embodiment, weight parameters may be stored in on-chip or off-chip memory and/or registers (shown or not shown) that configure ALUs of graphics processor 1300 to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

### Virtualized Computing Platform

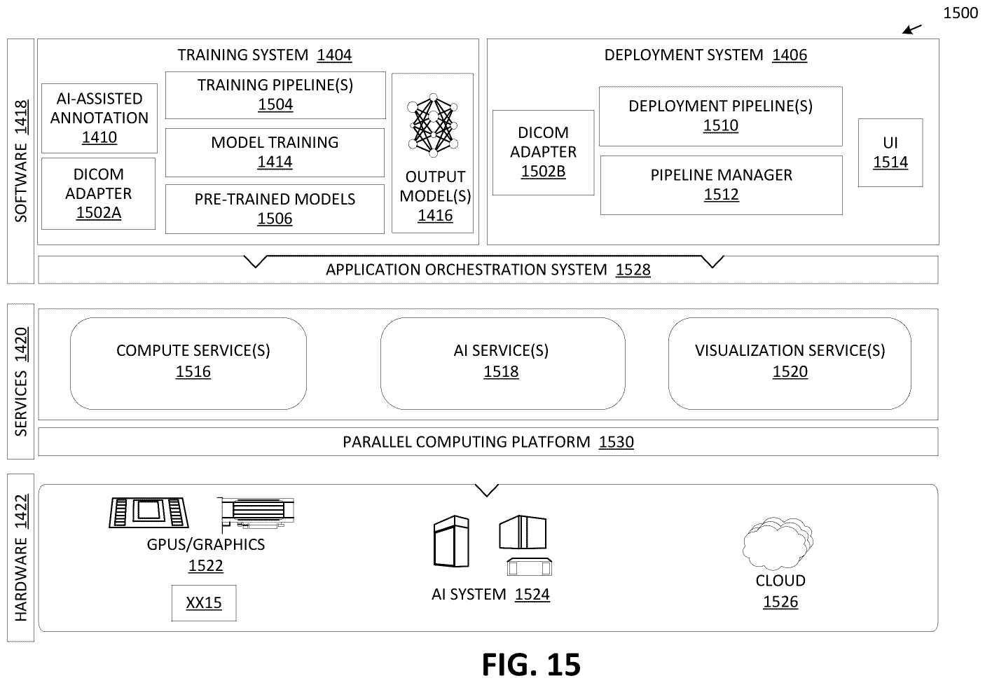

FIG. 14 is an example data flow diagram for a process 1400 of generating and deploying an image processing and inferencing pipeline, in accordance with at least one embodiment. In at least one embodiment, process 1400 may be deployed for use with imaging devices, processing devices, and/or other device types at one or more facilities 1402. Process 1400 may be executed within a training system 1404 and/or a deployment system 1406. In at least one embodiment, training system 1404 may be used to perform training, deployment, and implementation of machine learning models (e.g., neural networks, object detection algorithms, computer vision algorithms, etc.) for use in deployment system 1406. In at least one embodiment, deployment system 1406 may be configured to offload processing and compute resources among a distributed computing environment to reduce infrastructure requirements at facility 1402. In at least one embodiment, one or more applications in a pipeline may use or call upon services (e.g., inference, visualization, compute, AI, etc.) of deployment system 1406 during execution of applications.

In at least one embodiment, some of applications used in advanced processing and inferencing pipelines may use machine learning models or other AI to perform one or more processing steps. In at least one embodiment, machine learning models may be trained at facility 1402 using data 1408 (such as imaging data) generated at facility 1402 (and stored on one or more picture archiving and communication system (PACS) servers at facility 1402), may be trained using imaging or sequencing data 1408 from another facility(ies), or a combination thereof. In at least one embodiment, training system 1404 may be used to provide applications, services, and/or other resources for generating working, deployable machine learning models for deployment system 1406.

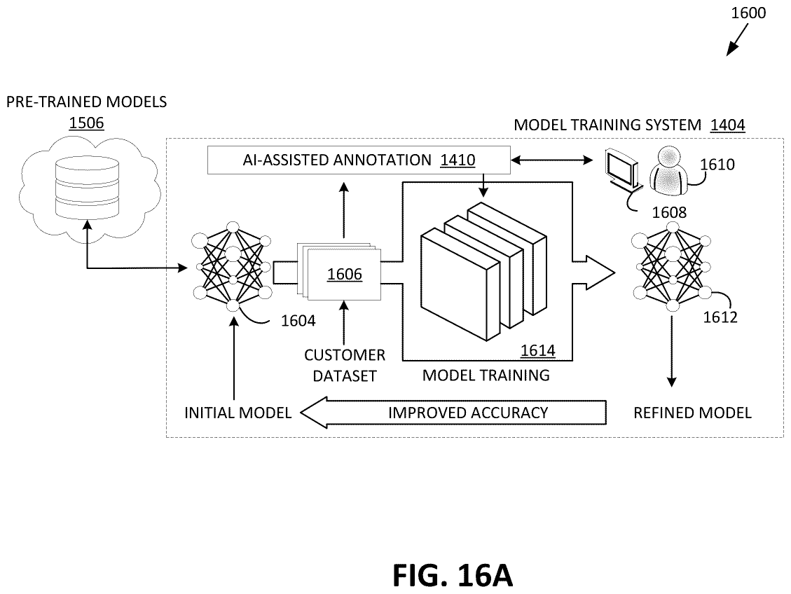

In at least one embodiment, model registry 1424 may be backed by object storage that may support versioning and object metadata. In at least one embodiment, object storage may be accessible through, for example, a cloud storage (e.g., cloud 1526 of FIG. 15) compatible application programming interface (API) from within a cloud platform. In at least one embodiment, machine learning models within model registry 1424 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1504 (FIG. 15) may include a scenario where facility 1402 is training their own machine learning model, or has an existing machine learning model that needs to be optimized or updated. In at least one embodiment, imaging data 1408 generated by imaging device(s), sequencing devices, and/or other device types may be received. In at least one embodiment, once imaging data 1408 is received, AI-assisted annotation 1410 may be used to aid in generating annotations corresponding to imaging data 1408 to be used as ground truth data for a machine learning model. In at least one embodiment, AI-assisted annotation 1410 may include one or more machine learning models (e.g., convolutional neural networks (CNNs)) that may be trained to generate annotations corresponding to certain types of imaging data 1408 (e.g., from certain devices). In at least one embodiment, AI-assisted annotations 1410 may then be used directly, or may be adjusted or fine-tuned using an annotation tool to generate ground truth data. In at least one embodiment, AI-assisted annotations 1410, labeled clinic data 1412, or a combination thereof may be used as ground truth data for training a machine learning model. In at least one embodiment, a trained machine learning model may be referred to as output model 1416, and may be used by deployment system 1406, as described herein.

In at least one embodiment, training pipeline 1504 (FIG. 15) may include a scenario where facility 1402 needs a machine learning model for use in performing one or more processing tasks for one or more applications in deployment system 1406, but facility 1402 may not currently have such a machine learning model (or may not have a model that is optimized, efficient, or effective for such purposes). In at least one embodiment, an existing machine learning model may be selected from a model registry 1424. In at least one embodiment, model registry 1424 may include machine learning models trained to perform a variety of different inference tasks on imaging data. In at least one embodiment, machine learning models in model registry 1424 may have been trained on imaging data from different facilities than facility 1402 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1424. In at least one embodiment, a machine learning model may then be retrained, or updated, at any number of other facilities, and a retrained or updated model may be made available in model registry 1424. In at least one embodiment, a machine learning model may then be selected from model registry 1424—and referred to as output model 1416— and may be used in deployment system 1406 to perform one or more processing tasks for one or more applications of a deployment system.

In at least one embodiment, training pipeline 1504 (FIG. 15), a scenario may include facility 1402 requiring a machine learning model for use in performing one or more processing tasks for one or more applications in deployment system 1406, but facility 1402 may not currently have such a machine learning model (or may not have a model that is optimized, efficient, or effective for such purposes). In at least one embodiment, a machine learning model selected from model registry 1424 may not be fine-tuned or optimized for imaging data 1408 generated at facility 1402 because of differences in populations, robustness of training data used to train a machine learning model, diversity in anomalies of training data, and/or other issues with training data. In at least one embodiment, AI-assisted annotation 1410 may be used to aid in generating annotations corresponding to imaging data 1408 to be used as ground truth data for retraining or updating a machine learning model. In at least one embodiment, labeled data 1412 may be used as ground truth data for training a machine learning model. In at least one embodiment, retraining or updating a machine learning model may be referred to as model training 1414. In at least one embodiment, model training 1414—e.g., AI-assisted annotations 1410, labeled clinic data 1412, or a combination thereof—may be used as ground truth data for retraining or updating a machine learning model. In at least one embodiment, a trained machine learning model may be referred to as output model 1416, and may be used by deployment system 1406, as described herein.

In at least one embodiment, deployment system 1406 may include software 1418, services 1420, hardware 1422, and/or other components, features, and functionality. In at least one embodiment, deployment system 1406 may include a software “stack,” such that software 1418 may be built on top of services 1420 and may use services 1420 to perform some or all of processing tasks, and services 1420 and software 1418 may be built on top of hardware 1422 and use hardware 1422 to execute processing, storage, and/or other compute tasks of deployment system 1406. In at least one embodiment, software 1418 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1408, in addition to containers that receive and configure imaging data for use by each container and/or for use by facility 1402 after processing through a pipeline (e.g., to convert outputs back to a usable data type). In at least one embodiment, a combination of containers within software 1418 (e.g., that make up a pipeline) may be referred to as a virtual instrument (as described in more detail herein), and a virtual instrument may leverage services 1420 and hardware 1422 to execute some or all processing tasks of applications instantiated in containers.

In at least one embodiment, a data processing pipeline may receive input data (e.g., imaging data 1408) in a specific format in response to an inference request (e.g., a request from a user of deployment system 1406). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1416 of training system 1404.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1424 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1420 as a system (e.g., system 1500 of FIG. 15). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1500 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1500 of FIG. 15). In at least one embodiment, completed and validated applications or containers may be stored in a container registry and associated machine learning models may be stored in model registry 1424. In at least one embodiment, a requesting entity—who provides an inference or image processing request—may browse a container registry and/or model registry 1424 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1406 (e.g., a cloud) to perform processing of data processing pipeline. In at least one embodiment, processing by deployment system 1406 may include referencing selected elements (e.g., applications, containers, models, etc.) from a container registry and/or model registry 1424. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1420 may be leveraged. In at least one embodiment, services 1420 may include compute services, artificial intelligence (AI) services, visualization services, and/or other service types. In at least one embodiment, services 1420 may provide functionality that is common to one or more applications in software 1418, so functionality may be abstracted to a service that may be called upon or leveraged by applications. In at least one embodiment, functionality provided by services 1420 may run dynamically and more efficiently, while also scaling well by allowing applications to process data in parallel (e.g., using a parallel computing platform 1530 (FIG. 15)). In at least one embodiment, rather than each application that shares a same functionality offered by a service 1420 being required to have a respective instance of service 1420, service 1420 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a service 1420 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1418 implementing advanced processing and inferencing pipeline that includes segmentation application and anomaly detection application may be streamlined because each application may call upon a same inference service to perform one or more inferencing tasks.

In at least one embodiment, hardware 1422 may include GPUs, CPUs, DPUs, graphics cards, an AI/deep learning system (e.g., an AI supercomputer, such as NVIDIA's DGX), a cloud platform, or a combination thereof. In at least one embodiment, different types of hardware 1422 may be used to provide efficient, purpose-built support for software 1418 and services 1420 in deployment system 1406. In at least one embodiment, use of GPU processing may be implemented for processing locally (e.g., at facility 1402), within an AI/deep learning system, in a cloud system, and/or in other processing components of deployment system 1406 to improve efficiency, accuracy, and efficacy of image processing and generation. In at least one embodiment, software 1418 and/or services 1420 may be optimized for GPU processing with respect to deep learning, machine learning, and/or high-performance computing, as non-limiting examples. In at least one embodiment, at least some of computing environment of deployment system 1406 and/or training system 1404 may be executed in a datacenter one or more supercomputers or high performance computing systems, with GPU optimized software (e.g., hardware and software combination of NVIDIA's DGX System). In at least one embodiment, hardware 1422 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform may further include DPU processing to transmit data received over a network and/or through a network controller or other network interface directly to (e.g., a memory of) one or more GPU(s). In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 15 is a system diagram for an example system 1500 for generating and deploying an imaging deployment pipeline, in accordance with at least one embodiment. In at least one embodiment, system 1500 may be used to implement process 1400 of FIG. 14 and/or other processes including advanced processing and inferencing pipelines. In at least one embodiment, system 1500 may include training system 1404 and deployment system 1406. In at least one embodiment, training system 1404 and deployment system 1406 may be implemented using software 1418, services 1420, and/or hardware 1422, as described herein.

In at least one embodiment, system 1500 (e.g., training system 1404 and/or deployment system 1406) may implemented in a cloud computing environment (e.g., using cloud 1526). In at least one embodiment, system 1500 may be implemented locally with respect to a healthcare services facility, or as a combination of both cloud and local computing resources. In at least one embodiment, access to APIs in cloud 1526 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1500, may be restricted to a set of public IPs that have been vetted or authorized for interaction.

In at least one embodiment, various components of system 1500 may communicate between and among one another using any of a variety of different network types, including but not limited to local area networks (LANs) and/or wide area networks (WANs) via wired and/or wireless communication protocols. In at least one embodiment, communication between facilities and components of system 1500 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1404 may execute training pipelines 1504, similar to those described herein with respect to FIG. 14. In at least one embodiment, where one or more machine learning models are to be used in deployment pipelines 1510 by deployment system 1406, training pipelines 1504 may be used to train or retrain one or more (e.g. pre-trained) models, and/or implement one or more of pre-trained models 1506 (e.g., without a need for retraining or updating). In at least one embodiment, as a result of training pipelines 1504, output model(s) 1416 may be generated. In at least one embodiment, training pipelines 1504 may include any number of processing steps, such as but not limited to imaging data (or other input data) conversion or adaption In at least one embodiment, for different machine learning models used by deployment system 1406, different training pipelines 1504 may be used. In at least one embodiment, training pipeline 1504 similar to a first example described with respect to FIG. 14 may be used for a first machine learning model, training pipeline 1504 similar to a second example described with respect to FIG. 14 may be used for a second machine learning model, and training pipeline 1504 similar to a third example described with respect to FIG. 14 may be used for a third machine learning model. In at least one embodiment, any combination of tasks within training system 1404 may be used depending on what is required for each respective machine learning model. In at least one embodiment, one or more of machine learning models may already be trained and ready for deployment so machine learning models may not undergo any processing by training system 1404, and may be implemented by deployment system 1406.

In at least one embodiment, output model(s) 1416 and/or pre-trained model(s) 1506 may include any types of machine learning models depending on implementation or embodiment. In at least one embodiment, and without limitation, machine learning models used by system 1500 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

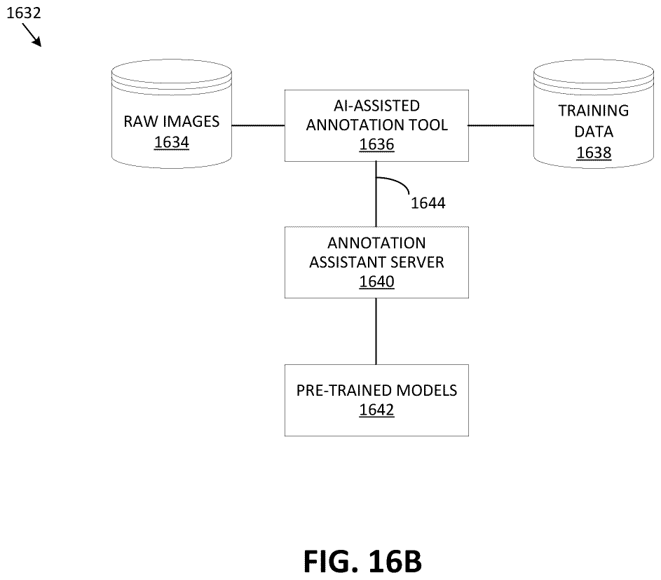

In at least one embodiment, training pipelines 1504 may include AI-assisted annotation, as described in more detail herein with respect to at least FIG. 16B. In at least one embodiment, labeled data 1412 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1408 (or other data type used by machine learning models), there may be corresponding ground truth data generated by training system 1404. In at least one embodiment, AI-assisted annotation may be performed as part of deployment pipelines 1510; either in addition to, or in lieu of AI-assisted annotation included in training pipelines 1504. In at least one embodiment, system 1500 may include a multi-layer platform that may include a software layer (e.g., software 1418) of diagnostic applications (or other application types) that may perform one or more medical imaging and diagnostic functions. In at least one embodiment, system 1500 may be communicatively coupled to (e.g., via encrypted links) PACS server networks of one or more facilities. In at least one embodiment, system 1500 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1402). In at least one embodiment, applications may then call or execute one or more services 1420 for performing compute, AI, or visualization tasks associated with respective applications, and software 1418 and/or services 1420 may leverage hardware 1422 to perform processing tasks in an effective and efficient manner.

In at least one embodiment, deployment system 1406 may execute deployment pipelines 1510. In at least one embodiment, deployment pipelines 1510 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline 1510 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline 1510 depending on information desired from data generated by a device. In at least one embodiment, where detections of anomalies are desired from an MM machine, there may be a first deployment pipeline 1510, and where image enhancement is desired from output of an Mill machine, there may be a second deployment pipeline 1510.

In at least one embodiment, an image generation application may include a processing task that includes use of a machine learning model. In at least one embodiment, a user may desire to use their own machine learning model, or to select a machine learning model from model registry 1424. In at least one embodiment, a user may implement their own machine learning model or select a machine learning model for inclusion in an application for performing a processing task. In at least one embodiment, applications may be selectable and customizable, and by defining constructs of applications, deployment, and implementation of applications for a particular user are presented as a more seamless user experience. In at least one embodiment, by leveraging other features of system 1500—such as services 1420 and hardware 1422—deployment pipelines 1510 may be even more user friendly, provide for easier integration, and produce more accurate, efficient, and timely results.

In at least one embodiment, deployment system 1406 may include a user interface 1514 (e.g., a graphical user interface, a web interface, etc.) that may be used to select applications for inclusion in deployment pipeline(s) 1510, arrange applications, modify, or change applications or parameters or constructs thereof, use and interact with deployment pipeline(s) 1510 during set-up and/or deployment, and/or to otherwise interact with deployment system 1406. In at least one embodiment, although not illustrated with respect to training system 1404, user interface 1514 (or a different user interface) may be used for selecting models for use in deployment system 1406, for selecting models for training, or retraining, in training system 1404, and/or for otherwise interacting with training system 1404.

In at least one embodiment, pipeline manager 1512 may be used, in addition to an application orchestration system 1528, to manage interaction between applications or containers of deployment pipeline(s) 1510 and services 1420 and/or hardware 1422. In at least one embodiment, pipeline manager 1512 may be configured to facilitate interactions from application to application, from application to service 1420, and/or from application or service to hardware 1422. In at least one embodiment, although illustrated as included in software 1418, this is not intended to be limiting, and in some examples (e.g., as illustrated in FIG. 13) pipeline manager 1512 may be included in services 1420. In at least one embodiment, application orchestration system 1528 (e.g., Kubernetes, DOCKER, etc.) may include a container orchestration system that may group applications into containers as logical units for coordination, management, scaling, and deployment. In at least one embodiment, by associating applications from deployment pipeline(s) 1510 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1512 and application orchestration system 1528. In at least one embodiment, so long as an expected input and/or output of each container or application is known by a system (e.g., based on constructs of applications or containers), application orchestration system 1528 and/or pipeline manager 1512 may facilitate communication among and between, and sharing of resources among and between, each of applications or containers. In at least one embodiment, because one or more of applications or containers in deployment pipeline(s) 1510 may share same services and resources, application orchestration system 1528 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1528) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1420 leveraged by and shared by applications or containers in deployment system 1406 may include compute services 1516, AI services 1518, visualization services 1520, and/or other service types. In at least one embodiment, applications may call (e.g., execute) one or more of services 1420 to perform processing operations for an application. In at least one embodiment, compute services 1516 may be leveraged by applications to perform super-computing or other high-performance computing (HPC) tasks. In at least one embodiment, compute service(s) 1516 may be leveraged to perform parallel processing (e.g., using a parallel computing platform 1530) for processing data through one or more of applications and/or one or more tasks of a single application, substantially simultaneously. In at least one embodiment, parallel computing platform 1530 (e.g., NVIDIA's CUDA) may enable general purpose computing on GPUs (GPGPU) (e.g., GPUs 1522). In at least one embodiment, a software layer of parallel computing platform 1530 may provide access to virtual instruction sets and parallel computational elements of GPUs, for execution of compute kernels. In at least one embodiment, parallel computing platform 1530 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1530 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1518 may be leveraged to perform inferencing services for executing machine learning model(s) associated with applications (e.g., tasked with performing one or more processing tasks of an application). In at least one embodiment, AI services 1518 may leverage AI system 1524 to execute machine learning model(s) (e.g., neural networks, such as CNNs) for segmentation, reconstruction, object detection, feature detection, classification, and/or other inferencing tasks. In at least one embodiment, applications of deployment pipeline(s) 1510 may use one or more of output models 1416 from training system 1404 and/or other models of applications to perform inference on imaging data. In at least one embodiment, two or more examples of inferencing using application orchestration system 1528 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1528 may distribute resources (e.g., services 1420 and/or hardware 1422) based on priority paths for different inferencing tasks of AI services 1518.

In at least one embodiment, shared storage may be mounted to AI services 1518 within system 1500. In at least one embodiment, shared storage may operate as a cache (or other storage device type) and may be used to process inference requests from applications. In at least one embodiment, when an inference request is submitted, a request may be received by a set of API instances of deployment system 1406, and one or more instances may be selected (e.g., for best fit, for load balancing, etc.) to process a request. In at least one embodiment, to process a request, a request may be entered into a database, a machine learning model may be located from model registry 1424 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1512) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s) and/or DPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<11 min). In at least one embodiment, model execution times may be measured from requesting institution or entity and may include partner network traversal time, as well as execution on an inference service.

In at least one embodiment, transfer of requests between services 1420 and inference applications may be hidden behind a software development kit (SDK), and robust transport may be provided through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1526, and an inference service may perform inferencing on a GPU.

In at least one embodiment, visualization services 1520 may be leveraged to generate visualizations for viewing outputs of applications and/or deployment pipeline(s) 1510. In at least one embodiment, GPUs 1522 may be leveraged by visualization services 1520 to generate visualizations. In at least one embodiment, rendering effects, such as ray-tracing, may be implemented by visualization services 1520 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1520 may include an internal visualizer, cinematics, and/or other rendering or image processing capabilities or functionality (e.g., ray tracing, rasterization, internal optics, etc.).

In at least one embodiment, hardware 1422 may include GPUs 1522, AI system 1524, cloud 1526, and/or any other hardware used for executing training system 1404 and/or deployment system 1406. In at least one embodiment, GPUs 1522 (e.g., s TESLA and/or QUADRO GPUs) may include any number of GPUs that may be used for executing processing tasks of compute services 1516, AI services 1518, visualization services 1520, other services, and/or any of features or functionality of software 1418. For example, with respect to AI services 1518, GPUs 1522 may be used to perform pre-processing on imaging data (or other data types used by machine learning models), post-processing on outputs of machine learning models, and/or to perform inferencing (e.g., to execute machine learning models). In at least one embodiment, cloud 1526, AI system 1524, and/or other components of system 1500 may use GPUs 1522. In at least one embodiment, cloud 1526 may include a GPU-optimized platform for deep learning tasks. In at least one embodiment, AI system 1524 may use GPUs, and cloud 1526— or at least a portion tasked with deep learning or inferencing—may be executed using one or more AI systems 1524. As such, although hardware 1422 is illustrated as discrete components, this is not intended to be limiting, and any components of hardware 1422 may be combined with, or leveraged by, any other components of hardware 1422.

In at least one embodiment, AI system 1524 may include a purpose-built computing system (e.g., a super-computer or an HPC) configured for inferencing, deep learning, machine learning, and/or other artificial intelligence tasks. In at least one embodiment, AI system 1524 (e.g., NVIDIA's DGX) may include GPU-optimized software (e.g., a software stack) that may be executed using a plurality of GPUs 1522, in addition to DPUs, CPUs, RAM, storage, and/or other components, features, or functionality. In at least one embodiment, one or more AI systems 1524 may be implemented in cloud 1526 (e.g., in a data center) for performing some or all of AI-based processing tasks of system 1500.

In at least one embodiment, cloud 1526 may include a GPU-accelerated infrastructure (e.g., NVIDIA's NGC) that may provide a GPU-optimized platform for executing processing tasks of system 1500. In at least one embodiment, cloud 1526 may include an AI system(s) 1524 for performing one or more of AI-based tasks of system 1500 (e.g., as a hardware abstraction and scaling platform). In at least one embodiment, cloud 1526 may integrate with application orchestration system 1528 leveraging multiple GPUs to enable seamless scaling and load balancing between and among applications and services 1420. In at least one embodiment, cloud 1526 may tasked with executing at least some of services 1420 of system 1500, including compute services 1516, AI services 1518, and/or visualization services 1520, as described herein. In at least one embodiment, cloud 1526 may perform small and large batch inference (e.g., executing NVIDIA's TENSOR RT), provide an accelerated parallel computing API and platform 1530 (e.g., NVIDIA's CUDA), execute application orchestration system 1528 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1500.

FIG. 16A illustrates a data flow diagram for a process 1600 to train, retrain, or update a machine learning model, in accordance with at least one embodiment. In at least one embodiment, process 1600 may be executed using, as a non-limiting example, system 1500 of FIG. 15. In at least one embodiment, process 1600 may leverage services 1420 and/or hardware 1422 of system 1500, as described herein. In at least one embodiment, refined models 1612 generated by process 1600 may be executed by deployment system 1406 for one or more containerized applications in deployment pipelines 1510.

In at least one embodiment, model training 1414 may include retraining or updating an initial model 1604 (e.g., a pre-trained model) using new training data (e.g., new input data, such as customer dataset 1606, and/or new ground truth data associated with input data). In at least one embodiment, to retrain, or update, initial model 1604, output or loss layer(s) of initial model 1604 may be reset, or deleted, and/or replaced with an updated or new output or loss layer(s). In at least one embodiment, initial model 1604 may have previously fine-tuned parameters (e.g., weights and/or biases) that remain from prior training, so training or retraining 1414 may not take as long or require as much processing as training a model from scratch. In at least one embodiment, during model training 1414, by having reset or replaced output or loss layer(s) of initial model 1604, parameters may be updated and re-tuned for a new data set based on loss calculations associated with accuracy of output or loss layer(s) at generating predictions on new, customer dataset 1606 (e.g., image data 1408 of FIG. 14).

In at least one embodiment, pre-trained models 1506 may be stored in a data store, or registry (e.g., model registry 1424 of FIG. 14). In at least one embodiment, pre-trained models 1506 may have been trained, at least in part, at one or more facilities other than a facility executing process 1600. In at least one embodiment, to protect privacy and rights of patients, subjects, or clients of different facilities, pre-trained models 1506 may have been trained, on-premise, using customer or patient data generated on-premise. In at least one embodiment, pre-trained models 1506 may be trained using cloud 1526 and/or other hardware 1422, but confidential, privacy protected patient data may not be transferred to, used by, or accessible to any components of cloud 1526 (or other off premise hardware). In at least one embodiment, where a pre-trained model 1506 is trained at using patient data from more than one facility, pre-trained model 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model 1506 on-premise and/or off premise, such as in a datacenter or other cloud computing infrastructure.

In at least one embodiment, when selecting applications for use in deployment pipelines 1510, a user may also select machine learning models to be used for specific applications. In at least one embodiment, a user may not have a model for use, so a user may select a pre-trained model 1506 to use with an application. In at least one embodiment, pre-trained model 1506 may not be optimized for generating accurate results on customer dataset 1606 of a facility of a user (e.g., based on patient diversity, demographics, types of medical imaging devices used, etc.). In at least one embodiment, prior to deploying pre-trained model 1506 into deployment pipeline 1510 for use with an application(s), pre-trained model 1506 may be updated, retrained, and/or fine-tuned for use at a respective facility.

In at least one embodiment, a user may select pre-trained model 1506 that is to be updated, retrained, and/or fine-tuned, and pre-trained model 1506 may be referred to as initial model 1604 for training system 1404 within process 1600. In at least one embodiment, customer dataset 1606 (e.g., imaging data, genomics data, sequencing data, or other data types generated by devices at a facility) may be used to perform model training 1414 (which may include, without limitation, transfer learning) on initial model 1604 to generate refined model 1612. In at least one embodiment, ground truth data corresponding to customer dataset 1606 may be generated by training system 1404. In at least one embodiment, ground truth data may be generated, at least in part, by clinicians, scientists, doctors, practitioners, at a facility (e.g., as labeled clinic data 1412 of FIG. 14).

In at least one embodiment, AI-assisted annotation 1410 may be used in some examples to generate ground truth data. In at least one embodiment, AI-assisted annotation 1410 (e.g., implemented using an AI-assisted annotation SDK) may leverage machine learning models (e.g., neural networks) to generate suggested or predicted ground truth data for a customer dataset. In at least one embodiment, user 1610 may use annotation tools within a user interface (a graphical user interface (GUI)) on computing device 1608.

In at least one embodiment, user 1610 may interact with a GUI via computing device 1608 to edit or fine-tune (auto)annotations. In at least one embodiment, a polygon editing feature may be used to move vertices of a polygon to more accurate or fine-tuned locations.

In at least one embodiment, once customer dataset 1606 has associated ground truth data, ground truth data (e.g., from AI-assisted annotation, manual labeling, etc.) may be used by during model training 1414 to generate refined model 1612. In at least one embodiment, customer dataset 1606 may be applied to initial model 1604 any number of times, and ground truth data may be used to update parameters of initial model 1604 until an acceptable level of accuracy is attained for refined model 1612. In at least one embodiment, once refined model 1612 is generated, refined model 1612 may be deployed within one or more deployment pipelines 1510 at a facility for performing one or more processing tasks with respect to medical imaging data.

In at least one embodiment, refined model 1612 may be uploaded to pre-trained models 1506 in model registry 1424 to be selected by another facility. In at least one embodiment, his process may be completed at any number of facilities such that refined model 1612 may be further refined on new datasets any number of times to generate a more universal model.

FIG. 16B is an example illustration of a client-server architecture 1632 to enhance annotation tools with pre-trained annotation models, in accordance with at least one embodiment. In at least one embodiment, AI-assisted annotation tools 1636 may be instantiated based on a client-server architecture 1632. In at least one embodiment, annotation tools 1636 in imaging applications may aid radiologists, for example, identify organs and abnormalities. In at least one embodiment, imaging applications may include software tools that help user 1610 to identify, as a non-limiting example, a few extreme points on a particular organ of interest in raw images 1634 (e.g., in a 3D Mill or CT scan) and receive auto-annotated results for all 2D slices of a particular organ. In at least one embodiment, results may be stored in a data store as training data 1638 and used as (for example and without limitation) ground truth data for training. In at least one embodiment, when computing device 1608 sends extreme points for AI-assisted annotation 1410, a deep learning model, for example, may receive this data as input and return inference results of a segmented organ or abnormality. In at least one embodiment, pre-instantiated annotation tools, such as AI-Assisted Annotation Tool 1636B in FIG. 16B, may be enhanced by making API calls (e.g., API Call 1644) to a server, such as an Annotation Assistant Server 1640 that may include a set of pre-trained models 1642 stored in an annotation model registry, for example. In at least one embodiment, an annotation model registry may store pre-trained models 1642 (e.g., machine learning models, such as deep learning models) that are pre-trained to perform AI-assisted annotation on a particular organ or abnormality. These models may be further updated by using training pipelines 1504. In at least one embodiment, pre-installed annotation tools may be improved over time as new labeled clinic data 1412 is added.

Such components may be used to generate synthetic data imitating failure cases in a network training process, which may help to improve performance of the network while limiting the amount of synthetic data to avoid overfitting.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data may be accomplished in a variety of ways such as by receiving data as a parameter of a function call or a call to an application programming interface. In some implementations, process of obtaining, acquiring, receiving, or inputting analog or digital data may be accomplished by transferring data via a serial or parallel interface. In another implementation, process of obtaining, acquiring, receiving, or inputting analog or digital data may be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data may be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
providing, via an application programming interface (API), a list of one or more available machine learning models (MLMs) to a remote client device;
receiving, via the API, an indication from the remote client device of one or more selected MLMs from the provided list of the one or more available MLMs;
identifying training settings for the one or more selected MLMs;
identifying a training data for the selected MLMs;
configuring, using the identified training settings, execution of one or more processes to train the one or more selected MLMs using the identified training data; and
providing, via the API, a representation of completed training of at least one MLM of the one or more selected MLM to the remote client device.

2. The method of claim 1, wherein the identified training settings comprise at least one of:
stored training settings;
user-modified stored training settings; or
user-generated training settings.

3. The method of claim 1, wherein configuring the execution of one or more processes to train the one or more selected MLM comprises:
managing execution of a plurality of sets of jobs on one or more processing devices, wherein individual sets of jobs from the plurality of sets of jobs correspond to updating respective MLMs of the one or more selected MLMs.

4. The method of claim 3, further comprising:
applying an evaluation metric to identify one or more preferred MLMs, wherein the representation of completed training comprises a representation of the one or more preferred MLMs; and
providing the representation of the one or more preferred MLMs to the remote client device.

5. The method of claim 1, further comprising:
receiving, from the remote client device, a selection of a user-preferred MLM from the one or more preferred MLMs; and
performing an optimization of the user-preferred MLM to generate an optimized MLM, wherein the optimization of the user-preferred MLM comprises at least one of:
pruning of neurons of the user-preferred MLM, or
quantization of parameters of the user-preferred MLM.

6. The method of claim 5, further comprising:
performing additional training of the optimized MLM.

7. The method of claim 1, wherein the API supports a set of user-selectable MLM-handling commands, and wherein the set of user-selectable MLM-handling commands comprises one or more of:
a train command,
a prune command,
a quantize command,
an evaluate command,
an export command,
an infer command, or
a data augmentation command.

8. The method of claim 1, further comprising:
receiving, from the remote client device, a selection of one or more user-preferred MLMs selected from the representation of completed training of at least one MLM of the one or more selected MLMs; and
deploying the one or more user-preferred MLM using user-accessible cloud-based hardware resources; and
making the one or more deployed user-preferred MLMs available to process a user input data.

9. The method of claim 8, wherein the user-accessible cloud-based hardware resources comprise one or more Graphics Processing Units (GPUs).

10. The method of claim 8, further comprising:
receiving the user input data;
causing the one or more deployed user-preferred MLMs to be applied to the user input data to generate an output data; and
providing a representation of the output data to the remote client device.

11. The method of claim 8, further comprising:
protecting, from unauthorized access, at least one of:
the one or more selected MLMs;
the training setting for the one or more selected MLMs; or
the training data.

12. A system comprising:
one or more processing devices to perform operations including:
providing, via an application programming interface (API), a list of one or more available machine learning models (MLMs) to a remote client device;
receiving, via the API, an indication from the remote client device of one or more selected MLMs from the provided list of the one or more available MLMs;
identifying training settings for the one or more selected MLMs;
identifying a training data for the selected MLMs;
configuring, using the identified training settings, execution of one or more processes to train the one or more selected MLMs using the identified training data; and
providing to the remote client device, via the API, a representation of completed training of at least one MLM of the one or more selected MLM.

13. The system of claim 12, wherein to configure the execution of one or more processes to train the one or more selected MLM, the processing device is to:
manage execution of a plurality of sets of jobs on one or more processing devices, wherein individual sets of jobs train respective MLMs of the one or more selected MLMs.

14. The system of claim 12, wherein the processing device is further to:
receive, from the remote client device, a selection of a user-preferred MLM from the one or more preferred MLMs; and
perform an optimization of the user-preferred MLM to generate an optimized MLM, wherein the optimization of the user-preferred MLM comprises at least one of:
pruning of neurons of the user-preferred MLM, or
quantization of parameters of the user-preferred MLM.

15. The system of claim 12, wherein the API supports a set of user-selectable MLM-handling commands, and wherein the set of user-selectable MLM-handling commands comprises one or more of:
a train command,
a prune command,
a quantize command,
an evaluate command,
an export command,
an infer command, or
a data augmentation command.

16. The system of claim 12, wherein the processing device is further to:
receive, from the remote client device, a selection of one or more user-preferred MLM selected from the representation of completed training of at least one MLM of the one or more selected MLM; and
deploy the one or more user-preferred MLM on user-accessible cloud-based hardware resources; and
make the one or more deployed user-preferred MLMs available to process a user input data.

17. The system of claim 16, wherein the user-accessible cloud-based hardware resources comprise one or more Graphics Processing Units (GPUs).

18. The system of claim 16, wherein the processing device is further to:
receive the user input data;
cause the one or more deployed user-preferred MLM to be applied to the user input data to generate an output data; and
provide, to the remote client device a representation of the output data.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of augmented reality content, virtual reality content, or mixed reality content;
a system implemented using a robot;
a system implemented using one or more language models;
a system for performing conversational AI operations;
a system for generating synthetic data;
a system incorporating one or more virtual machines (VMs);
a system implemented at least partially in a data center; or
a system implemented at least partially using cloud computing resources.

20. A processor comprising:
one or more processing units to:
provide a list of one or more available machine learning models (MLMs) to a remote client device via an application programming interface (API);
receive an indication from the remote client device and via the API of one or more selected MLMs from the provided list of the one or more available MLMs;
identify training settings and training data for the one or more selected MLMs;
configure execution of one or more processes to train the one or more selected MLMs using the identified training data and the identified training settings; and
provide a representation of completed training of at least one MLM of the one or more selected MLM to the remote client device via the API.
